(19) United States
(12) Patent Application Publication
(10) Pub. No.: US 2026/0289917 A1
(43) Pub. Date: Sep. 24, 2026

(54) EFFICIENT MULTI-VIEW RENDERING IN MULTI-USER SPLIT XR SYSTEMS

(71) Applicant: QUALCOMM Incorporated, San Diego, CA (US)

(72) Inventors: Pawan Kumar BAHETI, San Diego, CA (US); Wesley James HOLLAND, Encinitas, CA (US); Simon Peter William BOOTH, San Diego, CA (US); Rakesh Raju CHENNA MADHAVUNI, San Diego, CA (US); Kapil AHUJA, Bengaluru (IN)

(21) Appl. No.: 19/472,623

(22) PCT Filed: Apr. 23, 2024
(86) PCT No.: PCT/US2024/025838

§ 371 Date: Oct. 3, 2025

(30) Foreign Application Priority Data
May 12, 2023 (IN) 202341033562

(51) Int. Cl. G06T 19/00; G06F 3/01; G06T 7/70

(52) U.S. Cl. CPC G06T 19/006; G06F 3/011; G06T 7/70

(57) ABSTRACT

This disclosure provides systems, devices, apparatus, and methods, including computer programs encoded on storage media, for efficient multi-view rendering in multi-user split XR systems. A graphics processor may obtain first pose information for a first wearable display device and second pose information for a second wearable display device. The graphics processor may estimate a FOV of the first wearable display device and the second wearable display device based on at least one of the first pose information or the second pose information. The graphics processor may generate, based on the FOV, a frame for at least one of the first wearable display device or the second wearable display device. The graphics processor may transmit, for at least one of the first wearable display device or the second wearable display device, the frame.

### CROSS REFERENCE TO RELATED APPLICATIONS

This application claims the benefit of Indian Provisional Application No. 202341033562, entitled “EFFICIENT MULTI-VIEW RENDERING IN MULTI-USER SPLIT XR SYSTEMS” and filed on May 12, 2023, which is expressly incorporated by reference herein in its entirety.

### TECHNICAL FIELD

The present disclosure relates generally to processing systems, and more particularly, to one or more techniques for graphics and/or display processing.

### INTRODUCTION

Computing devices often perform graphics and/or display processing (e.g., utilizing a graphics processing unit (GPU), a central processing unit (CPU), a display processor, etc.) to render and display visual content. Such computing devices may include, for example, computer workstations, mobile phones such as smartphones, embedded systems, personal computers, tablet computers, and video game consoles. GPUs are configured to execute a graphics processing pipeline that includes one or more processing stages, which operate together to execute graphics processing commands and output a frame. A central processing unit (CPU) may control the operation of the GPU by issuing one or more graphics processing commands to the GPU. Modern day CPUs are typically capable of executing multiple applications concurrently, each of which may need to utilize the GPU during execution. A display processor may be configured to convert digital information received from a CPU to analog values and may issue commands to a display panel for displaying the visual content. A device that provides content for visual presentation on a display may utilize a CPU, a GPU, and/or a display processor.

Current techniques for split extended reality (XR) rendering for multiple devices may render different frames for each of the multiple devices. There is a need for improved techniques for split XR rendering for multiple devices.

### BRIEF SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus for graphics processing are provided. The apparatus includes a memory; and a processor coupled to the memory and, based on information stored in the memory, the processor is configured to: obtain first pose information for a first wearable display device and second pose information for a second wearable display device; estimate a field of view (FOV) of the first wearable display device and the second wearable display device based on at least one of the first pose information or the second pose information; generate, based on the FOV, a frame for at least one of the first wearable display device or the second wearable display device; and transmit, for at least one of the first wearable display device or the second wearable display device, the frame.

In an aspect of the disclosure, a method, a computer-readable medium, and an apparatus for display processing are provided. The apparatus includes a memory; and a processor coupled to the memory and, based on information stored in the memory, the processor is configured to: determine, based on at least one of first pose information or first motion information for a first wearable display device, an occlusion region of the first wearable display device; transmit, for at least one second wearable display device based on the determination, a request for texture data and depth data associated with the occlusion region; receive, from the at least one second wearable display device and based on the request, the texture data and the depth data associated with the occlusion region; and process, based on the texture data and the depth data, a frame associated with the occlusion region.

To the accomplishment of the foregoing and related ends, the one or more aspects include the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a block diagram that illustrates an example content generation system in accordance with one or more techniques of this disclosure.

FIG. 2 illustrates an example graphics processor (e.g., a graphics processing unit (GPU)) in accordance with one or more techniques of this disclosure.

FIG. 3 illustrates an example display framework including a display processor and a display in accordance with one or more techniques of this disclosure.

FIG. 4 is a diagram illustrating an example of a multiple user split extended reality (XR) system in accordance with one or more techniques of this disclosure.

FIG. 5 is a diagram illustrating another example of a multiple user split XR system in accordance with one or more techniques of this disclosure.

FIG. 6 is a call flow diagram illustrating example communications between a remote device, a first wearable display device, and a second wearable display device in accordance with one or more techniques of this disclosure.

FIG. 7 is a flowchart of an example method of graphics processing in accordance with one or more techniques of this disclosure.

FIG. 8 is a flowchart of an example method of display processing in accordance with one or more techniques of this disclosure.

FIG. 9 is a flowchart of an example method of graphics processing in accordance with one or more techniques of this disclosure.

FIG. 10 is a flowchart of an example method of display processing in accordance with one or more techniques of this disclosure.

### DETAILED DESCRIPTION

Various aspects of systems, apparatuses, computer program products, and methods are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of this disclosure to those skilled in the art. Based on the teachings herein one skilled in the art should appreciate that the scope of this disclosure is intended to cover any aspect of the systems, apparatuses, computer program products, and methods disclosed herein, whether implemented independently of, or combined with, other aspects of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. Any aspect disclosed herein may be embodied by one or more elements of a claim.

Although various aspects are described herein, many variations and permutations of these aspects fall within the scope of this disclosure. Although some potential benefits and advantages of aspects of this disclosure are mentioned, the scope of this disclosure is not intended to be limited to particular benefits, uses, or objectives. Rather, aspects of this disclosure are intended to be broadly applicable to different wireless technologies, system configurations, processing systems, networks, and transmission protocols, some of which are illustrated by way of example in the figures and in the following description. The detailed description and drawings are merely illustrative of this disclosure rather than limiting, the scope of this disclosure being defined by the appended claims and equivalents thereof.

Several aspects are presented with reference to various apparatus and methods. These apparatus and methods are described in the following detailed description and illustrated in the accompanying drawings by various blocks, components, circuits, processes, algorithms, and the like (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors (which may also be referred to as processing units). Examples of processors include microprocessors, microcontrollers, graphics processing units (GPUs), general purpose GPUs (GPGPUs), central processing units (CPUs), application processors, digital signal processors (DSPs), reduced instruction set computing (RISC) processors, systems-on-chip (SOCs), baseband processors, application specific integrated circuits (ASICs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software can be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

The term application may refer to software. As described herein, one or more techniques may refer to an application (e.g., software) being configured to perform one or more functions. In such examples, the application may be stored in a memory (e.g., on-chip memory of a processor, system memory, or any other memory). Hardware described herein, such as a processor may be configured to execute the application. For example, the application may be described as including code that, when executed by the hardware, causes the hardware to perform one or more techniques described herein. As an example, the hardware may access the code from a memory and execute the code accessed from the memory to perform one or more techniques described herein. In some examples, components are identified in this disclosure. In such examples, the components may be hardware, software, or a combination thereof. The components may be separate components or sub-components of a single component.

In one or more examples described herein, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can include a random access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

As used herein, instances of the term “content” may refer to “graphical content,” an “image,” etc., regardless of whether the terms are used as an adjective, noun, or other parts of speech. In some examples, the term “graphical content,” as used herein, may refer to a content produced by one or more processes of a graphics processing pipeline. In further examples, the term “graphical content,” as used herein, may refer to a content produced by a processing unit configured to perform graphics processing. In still further examples, as used herein, the term “graphical content” may refer to a content produced by a graphics processing unit. The term “reprojection” may refer to a process of warping rendered frames (i.e., rendered content) based on latest available pose information. The term “pose information” may refer to information that is related to a head pose at a device (e.g., a six degree-of-freedom (6DOF) pose including a position (xyz)). The term “motion information” may refer to information that is related to motion of a device. The term “depth frame” may refer to a frame that includes information pertaining to a distance at which an object in a frame is to be rendered with respect to a position of a user. The term “wearable display device” may refer to a device that is capable of being worn by a user to display content (e.g., a head device, a head mounted display (HMD), glasses, etc.). The term “workload” may refer to a workload that is processed at a graphics processor or a GPU (e.g., a vertex or pixel workload). The term “field of view” or “FOV” may refer to a range of an observable world that is visible at any given time through a human eye, through a camera viewfinder, or on a display screen. The term “occlusion” may refer to when one object is hidden in an image by a part of another object. The term “occlusion region” may refer a region that is occluded or hidden depending on a position of a camera relative to the scene.

An extended reality (XR) system (e.g., an augmented reality (AR) system, a virtual reality (VR) system, a mixed reality (MR) system) may include a remote device (e.g., a phone, a tablet, a desktop computing device, a laptop computing device, a server, etc.) and a wearable display device (e.g., a head device, a head mounted display (HMD), glasses, etc.) that communicate over a wired or wireless connection, where the wearable display device may be worn on/over/around eye(s) of a user. The wearable display device may have less battery life and less computational power in comparison to battery life and computational power of the remote device. As such, rendering and other workloads may be offloaded to the remote device. For instance, the remote device may receive pose information (e.g., a six degree-of-freedom (6DOF) pose including position (xyz) and orientation (roll, pitch, yaw)) of the wearable display device and the remote device may render a frame of XR content (e.g., AR content, MR content, VR content, etc.) based on the pose information and transmit the remote device may transmit the frame to the wearable display device.

Some XR systems may include a remote device and multiple wearable display devices (e.g., a first wearable display device worn by a first user and a second wearable display device worn by a second user). In an example, the first wearable display device and the second wearable display device may be located relatively near one another (e.g., within the same room) and/or the first wearable display device and the second wearable display device may be oriented towards the same or a similar direction (e.g., the first user and the second user may be looking at the same point (or nearby points) in the room while wearing the first wearable display device and the second wearable display device, respectively). The remote device may render first frame(s) for the first wearable display device and second frame(s) for the second wearable display device. The remote device may transmit the rendered first frame(s) to the first wearable display device and the remote device may transmit the rendered second frame(s) to the second wearable display device. However, this may be burdensome on computational resources and/or battery resources of the remote device, as the remote device renders the first frame(s) and the second frame(s) separately.

After receiving the rendered first frame(s) and the rendered second frame(s) from the remote device, the first wearable display device and the second wearable display device may respectively display the rendered first frame(s) and the rendered second frame(s). However, in some scenarios, rendered frame(s) may be occluded (i.e., blocked from view) or be at risk for occlusion by a physical object in a scene that is being viewed by a user.

Various technologies pertaining to efficient multiple view rendering in a multiple user split XR system are described herein. In an example, an apparatus (e.g., a remote device) obtains first pose information for a first wearable display device and second pose information for a second wearable display device. The apparatus (e.g., a remote device) estimates a field of view (FOV) of the first wearable display device and the second wearable display device based on at least one of the first pose information or the second pose information. The apparatus (e.g., a remote device) generates, based on the FOV, a frame (e.g., a single frame, a single frame and depth frames for the first wearable display device and the second wearable display device, etc.) for at least one of the first wearable display device or the second wearable display device. The apparatus (e.g., a remote device) transmits, for at least one of the first wearable display device or the second wearable display device, the frame. In another example, an apparatus (e.g., a wearable display device) determines, based on at least one of first pose information or first motion information for a first wearable display device, an occlusion region of the first wearable display device. The apparatus (e.g., a wearable display device) transmits, for at least one second wearable display device based on the determination, a request for texture data and depth data associated with the occlusion region. The apparatus (e.g., a wearable display device) receives, from the at least one second wearable display device and based on the request, the texture data and the depth data associated with the occlusion region. The apparatus (e.g., a wearable display device) processes, based on the texture data and the depth data, a frame associated with the occlusion region.

Vis-à-vis estimating the FOV based on the first pose information and the second pose information and generating the frame (e.g., a single frame, a single frame and depth frames for the first wearable display device and the second wearable display device, etc.) based on the estimated FOV, computational resources and/or battery resources may be conserved at the remote device, as the remote device may avoid generating different frames for different wearable display devices. Furthermore, vis-à-vis a first wearable computing device requesting and receiving texture and depth data from a second wearable computing device, the first wearable display device may efficiently fill in occlusion regions of the first wearable display device, which may improve a user experience.

The examples describe herein may refer to a use and functionality of a graphics processing unit (GPU). As used herein, a GPU can be any type of graphics processor, and a graphics processor can be any type of processor that is designed or configured to process graphics content. For example, a graphics processor or GPU can be a specialized electronic circuit that is designed for processing graphics content. As an additional example, a graphics processor or GPU can be a general purpose processor that is configured to process graphics content.

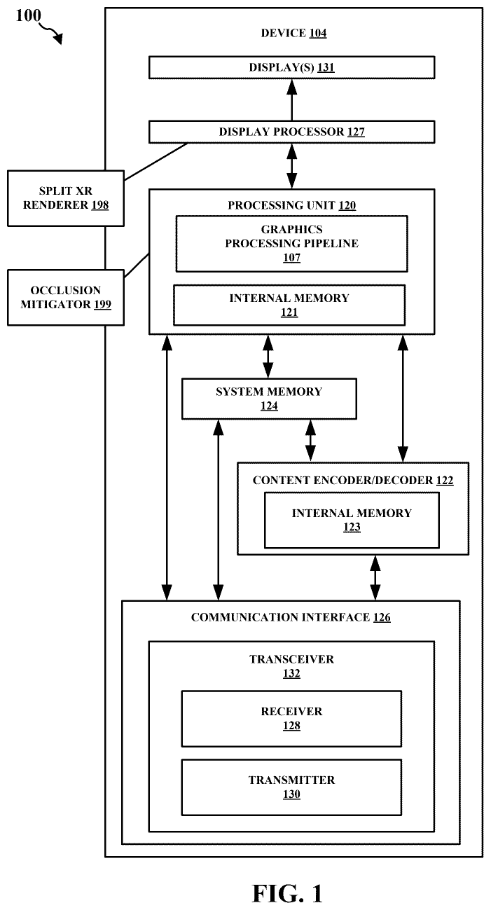

FIG. 1 is a block diagram that illustrates an example content generation system 100 configured to implement one or more techniques of this disclosure. The content generation system 100 includes a device 104. The device 104 may include one or more components or circuits for performing various functions described herein. In some examples, one or more components of the device 104 may be components of a SOC. The device 104 may include one or more components configured to perform one or more techniques of this disclosure. In the example shown, the device 104 may include a processing unit 120, a content encoder/decoder 122, and a system memory 124. In some aspects, the device 104 may include a number of components (e.g., a communication interface 126, a transceiver 132, a receiver 128, a transmitter 130, a display processor 127, and one or more displays 131). Display(s) 131 may refer to one or more displays 131. For example, the display 131 may include a single display or multiple displays, which may include a first display and a second display. The first display may be a left-eye display and the second display may be a right-eye display. In some examples, the first display and the second display may receive different frames for presentment thereon. In other examples, the first and second display may receive the same frames for presentment thereon. In further examples, the results of the graphics processing may not be displayed on the device, e.g., the first display and the second display may not receive any frames for presentment thereon. Instead, the frames or graphics processing results may be transferred to another device. In some aspects, this may be referred to as split-rendering.

The processing unit 120 may include an internal memory 121. The processing unit 120 may be configured to perform graphics processing using a graphics processing pipeline 107. The content encoder/decoder 122 may include an internal memory 123. In some examples, the device 104 may include a processor, which may be configured to perform one or more display processing techniques on one or more frames generated by the processing unit 120 before the frames are displayed by the one or more displays 131. While the processor in the example content generation system 100 is configured as a display processor 127, it should be understood that the display processor 127 is one example of the processor and that other types of processors, controllers, etc., may be used as substitute for the display processor 127. The display processor 127 may be configured to perform display processing. For example, the display processor 127 may be configured to perform one or more display processing techniques on one or more frames generated by the processing unit 120. The one or more displays 131 may be configured to display or otherwise present frames processed by the display processor 127. In some examples, the one or more displays 131 may include one or more of a liquid crystal display (LCD), a plasma display, an organic light emitting diode (OLED) display, a projection display device, an augmented reality display device, a virtual reality display device, a head-mounted display, or any other type of display device.

Memory external to the processing unit 120 and the content encoder/decoder 122, such as system memory 124, may be accessible to the processing unit 120 and the content encoder/decoder 122. For example, the processing unit 120 and the content encoder/decoder 122 may be configured to read from and/or write to external memory, such as the system memory 124. The processing unit 120 may be communicatively coupled to the system memory 124 over a bus. In some examples, the processing unit 120 and the content encoder/decoder 122 may be communicatively coupled to the internal memory 121 over the bus or via a different connection.

The content encoder/decoder 122 may be configured to receive graphical content from any source, such as the system memory 124 and/or the communication interface 126. The system memory 124 may be configured to store received encoded or decoded graphical content. The content encoder/decoder 122 may be configured to receive encoded or decoded graphical content, e.g., from the system memory 124 and/or the communication interface 126, in the form of encoded pixel data. The content encoder/decoder 122 may be configured to encode or decode any graphical content.

The internal memory 121 or the system memory 124 may include one or more volatile or non-volatile memories or storage devices. In some examples, internal memory 121 or the system memory 124 may include RAM, static random access memory (SRAM), dynamic random access memory (DRAM), erasable programmable ROM (EPROM), EEPROM, flash memory, a magnetic data media or an optical storage media, or any other type of memory. The internal memory 121 or the system memory 124 may be a non-transitory storage medium according to some examples. The term “non-transitory” may indicate that the storage medium is not embodied in a carrier wave or a propagated signal. However, the term “non-transitory” should not be interpreted to mean that internal memory 121 or the system memory 124 is non-movable or that its contents are static. As one example, the system memory 124 may be removed from the device 104 and moved to another device. As another example, the system memory 124 may not be removable from the device 104.

The processing unit 120 may be a CPU, a GPU, a GPGPU, or any other processing unit that may be configured to perform graphics processing. In some examples, the processing unit 120 may be integrated into a motherboard of the device 104. In further examples, the processing unit 120 may be present on a graphics card that is installed in a port of the motherboard of the device 104, or may be otherwise incorporated within a peripheral device configured to interoperate with the device 104. The processing unit 120 may include one or more processors, such as one or more microprocessors, GPUs, ASICs, FPGAs, arithmetic logic units (ALUs), DSPs, discrete logic, software, hardware, firmware, other equivalent integrated or discrete logic circuitry, or any combinations thereof. If the techniques are implemented partially in software, the processing unit 120 may store instructions for the software in a suitable, non-transitory computer-readable storage medium, e.g., internal memory 121, and may execute the instructions in hardware using one or more processors to perform the techniques of this disclosure. Any of the foregoing, including hardware, software, a combination of hardware and software, etc., may be considered to be one or more processors.

The content encoder/decoder 122 may be any processing unit configured to perform content decoding. In some examples, the content encoder/decoder 122 may be integrated into a motherboard of the device 104. The content encoder/decoder 122 may include one or more processors, such as one or more microprocessors, application specific integrated circuits (ASICs), field programmable gate arrays (FPGAs), arithmetic logic units (ALUs), digital signal processors (DSPs), video processors, discrete logic, software, hardware, firmware, other equivalent integrated or discrete logic circuitry, or any combinations thereof. If the techniques are implemented partially in software, the content encoder/decoder 122 may store instructions for the software in a suitable, non-transitory computer-readable storage medium, e.g., internal memory 123, and may execute the instructions in hardware using one or more processors to perform the techniques of this disclosure. Any of the foregoing, including hardware, software, a combination of hardware and software, etc., may be considered to be one or more processors.

In some aspects, the content generation system 100 may include a communication interface 126. The communication interface 126 may include a receiver 128 and a transmitter 130. The receiver 128 may be configured to perform any receiving function described herein with respect to the device 104. Additionally, the receiver 128 may be configured to receive information, e.g., eye or head position information, rendering commands, and/or location information, from another device. The transmitter 130 may be configured to perform any transmitting function described herein with respect to the device 104. For example, the transmitter 130 may be configured to transmit information to another device, which may include a request for content. The receiver 128 and the transmitter 130 may be combined into a transceiver 132. In such examples, the transceiver 132 may be configured to perform any receiving function and/or transmitting function described herein with respect to the device 104.

Referring again to FIG. 1, in certain aspects, the display processor may include a split XR renderer 198 configured to obtain first pose information for a first wearable display device and second pose information for a second wearable display device; estimate a field of view (FOV) of the first wearable display device and the second wearable display device based on at least one of the first pose information or the second pose information; generate, based on the FOV, a frame for at least one of the first wearable display device or the second wearable display device; and transmit, for at least one of the first wearable display device or the second wearable display device, the frame. In certain aspects, the display processor 127 may include an occlusion mitigator 199 configured to determine, based on at least one of first pose information or first motion information for a first wearable display device, an occlusion region of the first wearable display device; transmit, for at least one second wearable display device based on the determination, a request for texture data and depth data associated with the occlusion region; receive, from the at least one second wearable display device and based on the request, the texture data and the depth data associated with the occlusion region; and process, based on the texture data and the depth data, a frame associated with the occlusion region. Although the following description may be focused on graphics and display processing for wearable display devices, the concepts described herein may be applicable to graphics and display processing for non-wearable display devices.

A device, such as the device 104, may refer to any device, apparatus, or system configured to perform one or more techniques described herein. For example, a device may be a server, a base station, a user equipment, a client device, a station, an access point, a computer such as a personal computer, a desktop computer, a laptop computer, a tablet computer, a computer workstation, or a mainframe computer, an end product, an apparatus, a phone, a smart phone, a server, a video game platform or console, a handheld device such as a portable video game device or a personal digital assistant (PDA), a wearable computing device such as a smart watch, an augmented reality device, or a virtual reality device, a non-wearable device, a display or display device, a television, a television set-top box, an intermediate network device, a digital media player, a video streaming device, a content streaming device, an in-vehicle computer, any mobile device, any device configured to generate graphical content, or any device configured to perform one or more techniques described herein. Processes herein may be described as performed by a particular component (e.g., a GPU) but in other embodiments, may be performed using other components (e.g., a CPU) consistent with the disclosed embodiments.

GPUs can process multiple types of data or data packets in a GPU pipeline. For instance, in some aspects, a GPU can process two types of data or data packets, e.g., context register packets and draw call data. A context register packet can be a set of global state information, e.g., information regarding a global register, shading program, or constant data, which can regulate how a graphics context will be processed. For example, context register packets can include information regarding a color format. In some aspects of context register packets, there can be a bit or bits that indicate which workload belongs to a context register. Also, there can be multiple functions or programming running at the same time and/or in parallel. For example, functions or programming can describe a certain operation, e.g., the color mode or color format. Accordingly, a context register can define multiple states of a GPU.

Context states can be utilized to determine how an individual processing unit functions, e.g., a vertex fetcher (VFD), a vertex shader (VS), a shader processor, or a geometry processor, and/or in what mode the processing unit functions. In order to do so, GPUs can use context registers and programming data. In some aspects, a GPU can generate a workload, e.g., a vertex or pixel workload, in the pipeline based on the context register definition of a mode or state. Certain processing units, e.g., a VFD, can use these states to determine certain functions, e.g., how a vertex is assembled. As these modes or states can change, GPUs may need to change the corresponding context. Additionally, the workload that corresponds to the mode or state may follow the changing mode or state.

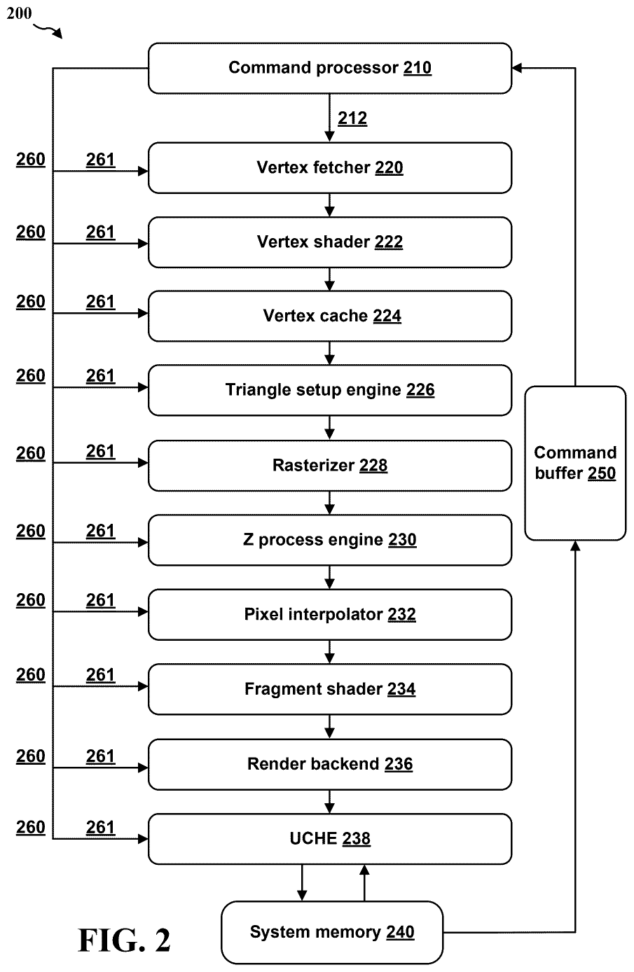

FIG. 2 illustrates an example GPU 200 in accordance with one or more techniques of this disclosure. As shown in FIG. 2, GPU 200 includes command processor (CP) 210, draw call packets 212, VFD 220, VS 222, vertex cache (VPC) 224, triangle setup engine (TSE) 226, rasterizer (RAS) 228, Z process engine (ZPE) 230, pixel interpolator (PI) 232, fragment shader (FS) 234, render backend (RB) 236, L2 cache (UCHE) 238, and system memory 240. Although FIG. 2 displays that GPU 200 includes processing units 220-238, GPU 200 can include a number of additional processing units. Additionally, processing units 220-238 are merely an example and any combination or order of processing units can be used by GPUs according to the present disclosure. GPU 200 also includes command buffer 250, context register packets 260, and context states 261.

As shown in FIG. 2, a GPU can utilize a CP, e.g., CP 210, or hardware accelerator to parse a command buffer into context register packets, e.g., context register packets 260, and/or draw call data packets, e.g., draw call packets 212. The CP 210 can then send the context register packets 260 or draw call packets 212 through separate paths to the processing units or blocks in the GPU. Further, the command buffer 250 can alternate different states of context registers and draw calls. For example, a command buffer can simultaneously store the following information: context register of context N, draw call(s) of context N, context register of context N+1, and draw call(s) of context N+1.

GPUs can render images in a variety of different ways. In some instances, GPUs can render an image using direct rendering and/or tiled rendering. In tiled rendering GPUs, an image can be divided or separated into different sections or tiles. After the division of the image, each section or tile can be rendered separately. Tiled rendering GPUs can divide computer graphics images into a grid format, such that each portion of the grid, i.e., a tile, is separately rendered. In some aspects of tiled rendering, during a binning pass, an image can be divided into different bins or tiles. In some aspects, during the binning pass, a visibility stream can be constructed where visible primitives or draw calls can be identified. A rendering pass may be performed after the binning pass. In contrast to tiled rendering, direct rendering does not divide the frame into smaller bins or tiles. Rather, in direct rendering, the entire frame is rendered at a single time (i.e., without a binning pass). Additionally, some types of GPUs can allow for both tiled rendering and direct rendering (e.g., flex rendering).

In some aspects, GPUs can apply the drawing or rendering process to different bins or tiles. For instance, a GPU can render to one bin, and perform all the draws for the primitives or pixels in the bin. During the process of rendering to a bin, the render targets can be located in GPU internal memory (GMEM). In some instances, after rendering to one bin, the content of the render targets can be moved to a system memory and the GMEM can be freed for rendering the next bin. Additionally, a GPU can render to another bin, and perform the draws for the primitives or pixels in that bin. Therefore, in some aspects, there might be a small number of bins, e.g., four bins, that cover all of the draws in one surface. Further, GPUs can cycle through all of the draws in one bin, but perform the draws for the draw calls that are visible, i.e., draw calls that include visible geometry. In some aspects, a visibility stream can be generated, e.g., in a binning pass, to determine the visibility information of each primitive in an image or scene. For instance, this visibility stream can identify whether a certain primitive is visible or not. In some aspects, this information can be used to remove primitives that are not visible so that the non-visible primitives are not rendered, e.g., in the rendering pass. Also, at least some of the primitives that are identified as visible can be rendered in the rendering pass.

In some aspects of tiled rendering, there can be multiple processing phases or passes. For instance, the rendering can be performed in two passes, e.g., a binning, a visibility or bin-visibility pass and a rendering or bin-rendering pass. During a visibility pass, a GPU can input a rendering workload, record the positions of the primitives or triangles, and then determine which primitives or triangles fall into which bin or area. In some aspects of a visibility pass, GPUs can also identify or mark the visibility of each primitive or triangle in a visibility stream. During a rendering pass, a GPU can input the visibility stream and process one bin or area at a time. In some aspects, the visibility stream can be analyzed to determine which primitives, or vertices of primitives, are visible or not visible. As such, the primitives, or vertices of primitives, that are visible may be processed. By doing so, GPUs can reduce the unnecessary workload of processing or rendering primitives or triangles that are not visible.

In some aspects, during a visibility pass, certain types of primitive geometry, e.g., position-only geometry, may be processed. Additionally, depending on the position or location of the primitives or triangles, the primitives may be sorted into different bins or areas. In some instances, sorting primitives or triangles into different bins may be performed by determining visibility information for these primitives or triangles. For example, GPUs may determine or write visibility information of each primitive in each bin or area, e.g., in a system memory. This visibility information can be used to determine or generate a visibility stream. In a rendering pass, the primitives in each bin can be rendered separately. In these instances, the visibility stream can be fetched from memory and used to remove primitives which are not visible for that bin.

Some aspects of GPUs or GPU architectures can provide a number of different options for rendering, e.g., software rendering and hardware rendering. In software rendering, a driver or CPU can replicate an entire frame geometry by processing each view one time. Additionally, some different states may be changed depending on the view. As such, in software rendering, the software can replicate the entire workload by changing some states that may be utilized to render for each viewpoint in an image. In certain aspects, as GPUs may be submitting the same workload multiple times for each viewpoint in an image, there may be an increased amount of overhead. In hardware rendering, the hardware or GPU may be responsible for replicating or processing the geometry for each viewpoint in an image. Accordingly, the hardware can manage the replication or processing of the primitives or triangles for each viewpoint in an image.

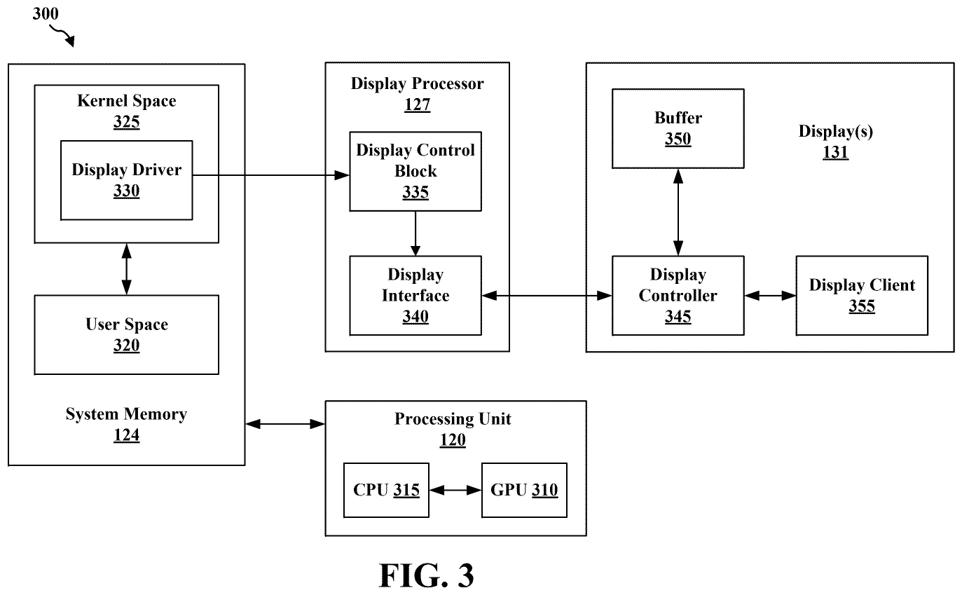

FIG. 3 is a block diagram 300 that illustrates an example display framework including the processing unit 120, the system memory 124, the display processor 127, and the display(s) 131, as may be identified in connection with the device 104.

A GPU may be included in devices that provide content for visual presentation on a display. For example, the processing unit 120 may include a GPU 310 configured to render graphical data for display on a computing device (e.g., the device 104), which may be a computer workstation, a mobile phone, a smartphone or other smart device, an embedded system, a personal computer, a tablet computer, a video game console, and the like. Operations of the GPU 310 may be controlled based on one or more graphics processing commands provided by a CPU 315. The CPU 315 may be configured to execute multiple applications concurrently. In some cases, each of the concurrently executed multiple applications may utilize the GPU 310 simultaneously. Processing techniques may be performed via the processing unit 120 output a frame over physical or wireless communication channels.

The system memory 124, which may be executed by the processing unit 120, may include a user space 320 and a kernel space 325. The user space 320 (sometimes referred to as an “application space”) may include software application(s) and/or application framework(s). For example, software application(s) may include operating systems, media applications, graphical applications, workspace applications, etc. Application framework(s) may include frameworks used by one or more software applications, such as libraries, services (e.g., display services, input services, etc.), application program interfaces (APIs), etc. The kernel space 325 may further include a display driver 330. The display driver 330 may be configured to control the display processor 127. For example, the display driver 330 may cause the display processor 127 to compose a frame and transmit the data for the frame to a display.

The display processor 127 includes a display control block 335 and a display interface 340. The display processor 127 may be configured to manipulate functions of the display(s) 131 (e.g., based on an input received from the display driver 330). The display control block 335 may be further configured to output image frames to the display(s) 131 via the display interface 340. In some examples, the display control block 335 may additionally or alternatively perform post-processing of image data provided based on execution of the system memory 124 by the processing unit 120.

The display interface 340 may be configured to cause the display(s) 131 to display image frames. The display interface 340 may output image data to the display(s) 131 according to an interface protocol, such as, for example, the MIPI DSI (Mobile Industry Processor Interface, Display Serial Interface). That is, the display(s) 131, may be configured in accordance with MIPI DSI standards. The MIPI DSI standard supports a video mode and a command mode. In examples where the display(s) 131 is/are operating in video mode, the display processor 127 may continuously refresh the graphical content of the display(s) 131. For example, the entire graphical content may be refreshed per refresh cycle (e.g., line-by-line). In examples where the display(s) 131 is/are operating in command mode, the display processor 127 may write the graphical content of a frame to a buffer 350.

In some such examples, the display processor 127 may not continuously refresh the graphical content of the display(s) 131. Instead, the display processor 127 may use a vertical synchronization (Vsync, VSync, or VSYNC) pulse to coordinate rendering and consuming of graphical content at the buffer 350. For example, when a Vsync pulse is generated, the display processor 127 may output new graphical content to the buffer 350. Thus, generation of the Vsync pulse may indicate that current graphical content has been rendered at the buffer 350.

Frames are displayed at the display(s) 131 based on a display controller 345, a display client 355, and the buffer 350. The display controller 345 may receive image data from the display interface 340 and store the received image data in the buffer 350. In some examples, the display controller 345 may output the image data stored in the buffer 350 to the display client 355. Thus, the buffer 350 may represent a local memory to the display(s) 131. In some examples, the display controller 345 may output the image data received from the display interface 340 directly to the display client 355.

The display client 355 may be associated with a touch panel that senses interactions between a user and the display(s) 131. As the user interacts with the display(s) 131, one or more sensors in the touch panel may output signals to the display controller 345 that indicate which of the one or more sensors have sensor activity, a duration of the sensor activity, an applied pressure to the one or more sensor, etc. The display controller 345 may use the sensor outputs to determine a manner in which the user has interacted with the display(s) 131. The display(s) 131 may be further associated with/include other devices, such as a camera, a microphone, and/or a speaker, that operate in connection with the display client 355.

Some processing techniques of the device 104 may be performed over three stages (e.g., stage 1: a rendering stage; stage 2: a composition stage; and stage 3: a display/transfer stage). However, other processing techniques may combine the composition stage and the display/transfer stage into a single stage, such that the processing technique may be executed based on two total stages (e.g., stage 1: the rendering stage; and stage 2: the composition/display/transfer stage). During the rendering stage, the GPU 310 may process a content buffer based on execution of an application that generates content on a pixel-by-pixel basis. During the composition and display stage(s), pixel elements may be assembled to form a frame that is transferred to a physical display panel/subsystem (e.g., the displays 131) that displays the frame.

Instructions executed by a CPU (e.g., software instructions) or a display processor may cause the CPU or the display processor to search for and/or generate a composition strategy for composing a frame based on a dynamic priority and runtime statistics associated with one or more composition strategy groups. A frame to be displayed by a physical display device, such as a display panel, may include a plurality of layers. Also, composition of the frame may be based on combining the plurality of layers into the frame (e.g., based on a frame buffer). After the plurality of layers are combined into the frame, the frame may be provided to the display panel for display thereon. The process of combining each of the plurality of layers into the frame may be referred to as composition, frame composition, a composition procedure, a composition process, or the like.

A frame composition procedure or composition strategy may correspond to a technique for composing different layers of the plurality of layers into a single frame. The plurality of layers may be stored in doubled data rate (DDR) memory. Each layer of the plurality of layers may further correspond to a separate buffer. A composer or hardware composer (HWC) associated with a block or function may determine an input of each layer/buffer and perform the frame composition procedure to generate an output indicative of a composed frame. That is, the input may be the layers and the output may be a frame composition procedure for composing the frame to be displayed on the display panel.

Some aspects of display processing may utilize different types of mask layers, e.g., a shape mask layer. A mask layer is a layer that may represent a portion of a display or display panel. For instance, an area of a mask layer may correspond to an area of a display, but the entire mask layer may depict a portion of the content that is actually displayed at the display or panel. For example, a mask layer may include a top portion and a bottom portion of a display area, but the middle portion of the mask layer may be empty. In some examples, there may be multiple mask layers to represent different portions of a display area. Also, for certain portions of a display area, the content of different mask layers may overlap with one another. Accordingly, a mask layer may represent a portion of a display area that may or may not overlap with other mask layers.

A user may wear a display device in order to experienced extended reality (XR) content. XR may refer to a technology that blends aspects of a digital experience and the real world. XR may include augmented reality (AR), mixed reality (MR), and/or virtual reality (VR). In AR, AR objects may be superimposed on a real-world environment as perceived through the display device. In an example, AR content may be experienced through AR glasses that include a transparent or semi-transparent surface. An AR object may be projected onto the transparent or semi-transparent surface of the glasses as a user views an environment through the glasses. In general, the AR object may not be present in the real world and the user may not interact with the AR object. In MR, MR objects may be superimposed on a real-world environment as perceived through the display device and the user may interact with the MR objects. In some aspects, MR objects may include “video see through” with virtual content added. In an example, the user may “touch” a MR object being displayed to the user (i.e., the user may place a hand at a location in the real world where the MR object appears to be located from the perspective of the user), and the MR object may “move” based on the MR object being touched (i.e., a location of the MR object on a display may change). In general, MR content may be experienced through MR glasses (similar to AR glasses) worn by the user or through a head mounted display (HMD) worn by the user. The HMD may include a camera and one or more display panels. The HMD may capture an image of environment as perceived through the camera and display the image of the environment to the user with MR objects overlaid thereon. Unlike the transparent or semi-transparent surface of the AR/MR glasses, the one or more display panels of the HMD may not be transparent or semi-transparent. In VR, a user may experience a fully-immersive digital environment in which the real-world is blocked out. VR content may be experienced through a HMD.

A split XR system may include a single remote device (i.e., a companion device) that renders frames for multiple wearable display devices (e.g., HMDs). The remote device may achieve rendering efficiencies in cases where users wearing the wearable display devices are located relatively close together and facing the same direction or a similar direction while wearing the wearable display devices.

In a first aspect, a remote device may render a single (identical) frame and the remote device may send the single rendered frame to both a first HMD and a second HMD. The first HMD and the second HMD may perform independent late stage reprojection (LSR) on the single rendered frame. LSR may refer to a wearable display device warping rendered frames (i.e., rendered content) received from a remote device based on latest available pose information at the wearable display device. LSR may also be referred to as reprojection or asynchronous reprojection. Reprojection may account for a change in location/orientation of the wearable display device between a time at which the frame is rendered at the remote device and a time at which the rendered frame is displayed at the wearable display device. LSR may be performed by executing LSR algorithms such as asynchronous depth based reprojection, asynchronous timewarp, asynchronous spacewarp, and motion smoothing.

In a second aspect, a remote device may render a single extra-large frame encompassing a field of view (FOV) of both a first HMD and a second HMD. The remote device may send the single extra-large frame to both the first HMD and the second HMD. The first HMD and the second HMD may perform independent LSR on the extra-large frame.

In a third aspect, the remote device may utilize multiple frame (multi-frame) rendering techniques to render a first frame for a first HMD and a second frame for a second HMD. The remote device may send the first frame to the first HMD and the second frame to the second HMD. The first HMD may perform (independent) LSR on the first frame and the second HMD may perform (independent) LSR on the second frame.

In the first aspect, the second aspect, or the third aspect, the remote device may select (i.e., choose) (1) a first pose of the first HMD, (2) a second pose of the second HMD, or (3) an average pose of the first HMD and the second HMD (or some other pose that is representative of poses of the first HMD and the second HMD). The remote device may send the aforementioned selected pose (i.e., the selected render pose) alongside an eye-buffer to the first HMD and the second HMD. The first HMD and the second HMD may use the aforementioned selected pose in performing LSR.

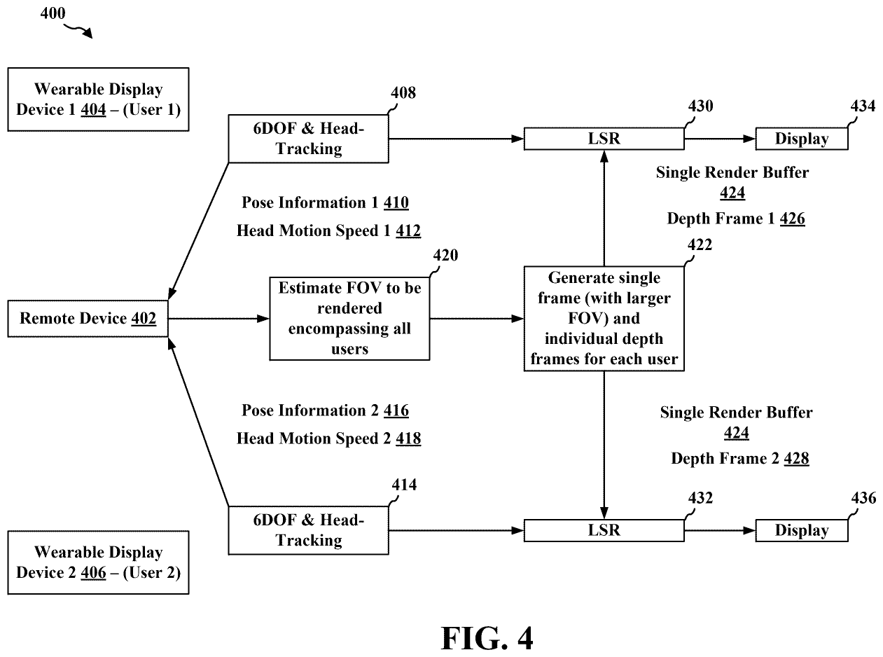

FIG. 4 is a diagram 400 illustrating an example of a multiple user split XR system. The multiple user split XR system may include a remote device 402, a first wearable display device 404 worn by a first user, and a second wearable display device 406 worn by a second user. As described in greater detail below, a workload of the remote device 402 (i.e., a companion workload) may be optimized in a multiple user split XR setup. For instance, the remote device 402 may generate a single frame for the first wearable display device 404 and the second wearable display device 406 (as opposed to separate frames for the first wearable display device 404 and the second wearable display device 406). The multiple user split XR system may be suitable for use in scenarios in which the first user and the second user are looking in the same or a similar direction while wearing the first wearable display device 404 and the second wearable display device 406, respectively.

The remote device 402 may be or include phone(s), such as smartphone(s), tablet(s), desktop computing device(s), laptop computing device(s), server(s), such as cloud servers, and/or gaming console(s). The remote device may alternatively be referred to as a companion device or a host. In an example, the first wearable display device 404 may be a first HMD or first XR glasses and the second wearable display device 406 may be a second HMD or second XR glasses. The first wearable display device 404 and the second wearable display device 406 may also be referred to as headsets. The remote device may be connected to the first wearable display device 404 and the second wearable display device 406 by wired connection(s) (e.g., universal serial bus (USB)) or wireless connection(s) (e.g., wireless local area network, 5G New Radio (NR), another cellular technology, etc.). In an example, the remote device 402 may be the device 104. In another example, the first wearable display device 404 may be the device 104. In yet another example, the second wearable display device 406 may be the device 104. Although the following description below focuses on two wearable display devices, the concepts presented below may be applicable to any number of wearable display devices (e.g., N wearable display devices, where N is a positive integer).

In general, the remote device 402 may be configured to render XR content and transmit the XR content to the first wearable display device 404 and the second wearable display device 406. In general, the first wearable display device 404 and the second wearable display device 406 may be configured to receive the rendered XR content, process the rendered XR content (explained in greater detail below), and present the processed rendered XR content on display(s). In one aspect, a wearable display device (e.g., the first wearable display device 404, the second wearable display device 406, etc.) may include a first display and a second display. When the wearable display device is worn by a user, the first display and the second display may be located within several centimeters of a first eye of the user and a second eye of the user, respectively. The wearable display device may present first processed rendered content on the first display concurrently (or nearly concurrently) with presenting second processed rendered content on the second display, where the first processed rendered content may be viewed by the first eye and the second processed rendered content may be viewed by the second eye. In an example, when viewed by the user, the first processed rendered content and the second processed rendered content may be perceived to be an object present in an environment of the user.

At 408, the first wearable display device 404 may determine first pose information 410 and a first head motion speed 412 of the first wearable display device 404 (and hence the first user). As used herein, pose information may refer to a current location (e.g., an xyz coordinate) and orientation (e.g., a roll, a pitch, and a yaw) of a wearable display device (and hence, a head of a user of the wearable display device). Pose information may be alternatively referred to as a six degree-of-freedom pose (6DOF). As used herein, head motion speed may refer to a speed of a head of a user while the user wears a wearable display device. Determining a head motion speed may also be referred to as head-tracking. In an example, the first wearable display device 404 may determine the first pose information 410 and the first head motion speed 412 by way of an inertial measurement unit (IMU) of the first wearable display device 404. The first wearable display device 404 may transmit the first pose information 410 and/or an indication of the first head motion speed 412 to the remote device 402. The first wearable display device 404 may also transmit additional information to the remote device 402, such as camera images captured by a camera of the first wearable display device 404, input by the first user of the first wearable display device 404 (e.g., controller input, voice input, etc.), a state of an application running on the first wearable display device 404, etc.

At 414, the second wearable display device 406 may determine second pose information 416 and a second head motion speed 418 of the second wearable display device 406 (and hence the second user). In an example, the second wearable display device 406 may determine the second pose information 416 and the second head motion speed 418 by way of an IMU of the second wearable display device 406. The second wearable display device 406 may transmit the second pose information 416 and/or an indication of the second head motion speed 418 to the remote device 402. The second wearable display device 406 may also transmit additional information to the remote device 402, such as camera images captured by a camera of the second wearable display device 406, input by the second user of the second wearable display device 406, a state of an application running on the second wearable display device 406, etc.

At 420, the remote device 402 may estimate a FOV of the first wearable display device 404 and the second wearable display device 406 (i.e., a FOV encompassing both the first wearable display device 404 and the second wearable display device 406) based on the first pose information 410 and the second pose information 416. Additionally, the remote device 402 may further estimate the FOV based on the first head motion speed 412 and/or the second head motion speed 418.

At 422, the remote device 402 may generate a single frame (e.g., generate a single render buffer 424 that includes the single frame) based on the FOV estimated at 420 (i.e., a single frame with a larger FOV). The remote device 402 may also generate individual depth frames for each user. As used herein, a depth frame may refer to a frame that includes information pertaining to a distance at which an object in a frame is to be rendered with respect to a position of a user. For instance, the remote device 402 may generate a first depth frame 426 based on the first pose information 410 and/or the first head motion speed 412 and the remote device 402 may generate a second depth frame 428 based on the second pose information 416 and/or the second head motion speed 418. The remote device 402 may additionally generate the single render buffer 424, the first depth frame 426, and/or the second depth frame 428 based on the additional information transmitted by the first wearable display device 404 and/or based on the additional information transmitted by the second wearable display device 406. The remote device 402 may transmit the single render buffer 424 and the first depth frame 426 to the first wearable display device 404. The remote device 402 may transmit the single render buffer 424 and the second depth frame 428 to the second wearable display device 406.

At 430, the first wearable display device 404 may perform LSR on the single render buffer 424 and/or the first depth frame 426. For instance, the first wearable display device 404 may perform LSR based on current pose information of the first wearable display device 404. At 432, the second wearable display device 406 may perform LSR on the single render buffer 424 and/or the second depth frame 428. For instance, the second wearable display device 406 may perform LSR based on current pose information of the second wearable display device 406. At 434, based on performing the LSR, the first wearable display device 404 may display a rendered frame (e.g., a frame from the perspective of the first user) on display panel(s) of the first wearable display device 404. At 436, based on performing the LSR, the second wearable display device 406 may display a rendered frame (e.g., a frame from the perspective of the second user) on display panel(s) of the second wearable display device 406.

In one aspect, the remote device 402 may generate (i.e., render) a single frame (and not the first depth frame 426 and the second depth frame 428). In such an aspect, the remote device 402 may generate the single frame from a viewpoint in between the first wearable display device 404 and the second wearable display device 406. The remote device 402 may determine the viewpoint based on the first pose information 410 and the second pose information 416. The remote device 402 may further determine the viewpoint based on the first head motion speed 412 and the second head motion speed 418. The remote device 402 may determine first offset pose information for the first wearable display device 404 based on the first pose information 410 and/or the first head motion speed 412, where the first offset pose information indicates a manner in which the first wearable display device 404 is to warp the single frame to fit a pose of the first wearable display device 404. The remote device 402 may determine second offset pose information for the second wearable display device 406 based on the second pose information 416 and/or the second head motion speed 418, where the second offset pose information indicates a manner in which the second wearable display device 406 is to warp the single frame to fit a pose of the second wearable display device 406. The remote device 402 may transmit the first offset pose information and the second offset pose information to the first wearable display device 404 and the second wearable display device 406, respectively. The first wearable display device 404 and the second wearable display device 406 may warp the single frame based on the first offset pose information and the second offset pose information, respectively. The first wearable display device 404 and the second wearable display device 406 may present the warped single frame on their respective display panel(s).

In one aspect, the remote device 402 may generate (i.e., render) a single frame (and not the first depth frame 426 and the second depth frame 428). In such an aspect, the remote device 402 may generate the single frame from a viewpoint of the first wearable display device 404 or the second wearable display device 406. In an example, the remote device 402 may generate the single frame from the viewpoint of the first wearable display device 404. The remote device 402 may determine offset pose information for the second wearable display device 406 based on the first pose information 410, the first head motion speed 412, the second pose information 416, and/or the second head motion speed 418. The remote device 402 may transmit the offset pose information to the second wearable display device 406. The second wearable display device 406 may warp the single frame based on the offset pose information. The second wearable display device 406 may present the warped single frame on display panel(s). The first wearable display device 404 may present the single frame on display panel(s) without warping the single frame.

In one aspect, the remote device 402 may render a first frame for the first wearable display device 404 and a second frame for the second wearable display device 406 utilizing multiple view (multi-view) rendering techniques in order to increase a speed at which the first frame and the second frame are rendered.

In one aspect, the rendering of the single frame as described above may be enabled or disabled based on metrics (i.e., a difference in pose of two headsets). In an example, the remote device 402 may compute a difference between first value(s) of the first pose information 410 and second value(s) of the second pose information 416. For example, the remote device 402 may compute a difference between a horizontal position (x-coordinate) of the first wearable display device 404 and a horizontal position (x-coordinate) of the second wearable display device 406. The remote device 402 may enable or disable the rendering of the single frame as described above based on the computed difference between the first value(s) and the second value(s) and threshold value(s).

In a split XR system with multiple users, occlusion-aware LSR quality may benefit from texture data and depth data of other users. For instance, in cases in which rendered content of an HMD is occluded or at risk of becoming occluded (by an object in a scene), the first HMD may indicate to second HMD(s) in an area that the first HMD's view is at risk of occlusion. The first HMD may request texture data and depth data from the second HMD(s). The first HMD may receive the requested texture data and depth data from the second HMD(s). The first HMD may fill occluded areas with the texture data and the depth data.

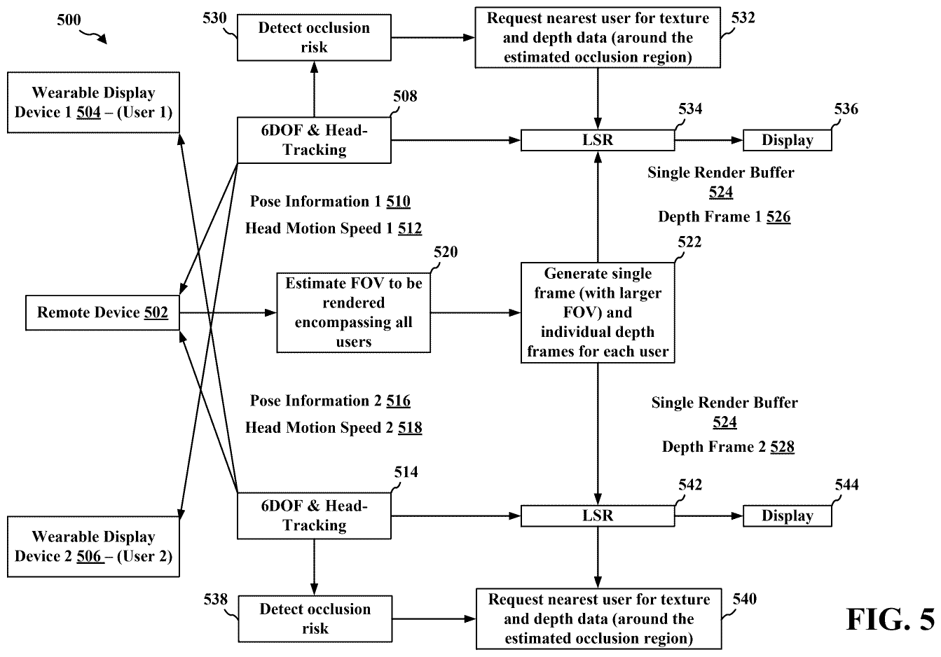

FIG. 5 is a diagram 500 illustrating another example of a multiple user split XR system. The multiple user split XR system may include a remote device 502, a first wearable display device 504 worn by a first user, and a second wearable display device 506 worn by a second user. As described in greater detail below, the multiple user split XR system may utilize occlusion-aware reprojection. For instance, a wearable display device in the multiple user split XR system may collaborate with other wearable display devices for incremental information, where a host may be sending a common frame with a large FOV as described above in the description of FIG. 5. In the multiple user split XR system, each user may be aware of 6DOF/head pose of other users.

The remote device 502 may be or include phone(s), such as smartphone(s), tablet(s), desktop computing device(s), laptop computing device(s), server(s), such as cloud servers, and/or gaming console(s). The remote device may alternatively be referred to as a companion device or a host. In an example, the first wearable display device 504 may be a first HMD or first XR glasses and the second wearable display device 506 may be a second HMD or second XR glasses. The first wearable display device 504 and the second wearable display device 506 may also be referred to as headsets. The remote device may be connected to the first wearable display device 504 and the second wearable display device 506 by wired connection(s) (e.g., universal serial bus (USB)) or wireless connection(s) (e.g., wireless local area network (WLAN), 5G New Radio (NR), another cellular technology, etc.). In an example, the remote device 502 may be the device 104. In another example, the first wearable display device 504 may be the device 104. In yet another example, the second wearable display device 506 may be the device 104. Although the following description below focuses on two wearable display devices, the concepts presented below may be applicable to any number of wearable display devices (e.g., N wearable display devices, where N is a positive integer).

In general, the remote device 502 may be configured to render XR content and transmit the XR content to the first wearable display device 504 and the second wearable display device 506. In general, the first wearable display device 504 and the second wearable display device 506 may be configured to receive the rendered XR content, process the rendered XR content (explained in greater detail below), and present the processed rendered XR content on display(s). In one aspect, a wearable display device (e.g., the first wearable display device 504 and the second wearable display device 506) may include a first display and a second display. When the wearable display device is worn by a user, the first display and the second display may be located within several centimeters of a first eye of the user and a second eye of the user, respectively. The wearable display device may present first processed rendered content on the first display concurrently (or nearly concurrently) with presenting second processed rendered content on the second display, where the first processed rendered content may be viewed by the first eye and the second processed rendered content may be viewed by the second eye. In an example, when viewed by the user, the first processed rendered content and the second processed rendered content may be perceived to be an object present in an environment of the user.

At 508, the first wearable display device 504 may determine first pose information 510 and a first head motion speed 512 of the first wearable display device 504 (and hence the first user). In an example, the first wearable display device 504 may determine the first pose information 510 and the first head motion speed 512 by way of an inertial measurement unit (IMU) of the first wearable display device 504. The first wearable display device 504 may transmit the first pose information 510 and/or an indication of the first head motion speed 512 to the remote device 502 and to the second wearable display device 506. The first wearable display device 504 may also transmit additional information to the remote device 502, such as camera images captured by a camera of the first wearable display device 504, input by the first user of the first wearable display device 504 (e.g., controller input, voice input, etc.), a state of an application running on the first wearable display device 504, etc.

At 514, the second wearable display device 506 may determine second pose information 516 and a second head motion speed 518 of the second wearable display device 506 (and hence the second user). In an example, the second wearable display device 506 may determine the second pose information 516 and the second head motion speed 518 by way of an IMU of the second wearable display device 506. The second wearable display device 506 may transmit the second pose information 516 and/or an indication of the second head motion speed 518 to the remote device 502 and to the first wearable display device 504. The second wearable display device 506 may also transmit additional information to the remote device 502, such as camera images captured by a camera of the second wearable display device 506, input by the second user of the second wearable display device 506, a state of an application running on the second wearable display device 506, etc.

At 520, the remote device 502 may estimate a FOV of the first wearable display device 504 and the second wearable display device 506 (i.e., a FOV encompassing both the first wearable display device 504 and the second wearable display device 506) based on the first pose information 510 and the second pose information 516. Additionally, the remote device 502 may further estimate the FOV based on the first head motion speed 512 and the second head motion speed 518.

At 522, the remote device 502 may generate a single frame (e.g., generate a single render buffer 524 that includes the single frame) based on the FOV estimated at 520 (i.e., a single frame with a larger FOV). The remote device 502 may also generate individual depth frames for each user. For instance, the remote device 502 may generate a first depth frame 526 based on the first pose information 510 and/or the first head motion speed 512 and the remote device 502 may generate a second depth frame 528 based on the second pose information 516 and/or the second head motion speed 518. The remote device 502 may additionally generate the single render buffer 524, the first depth frame 526, and/or the second depth frame 528 based on the additional information transmitted by the first wearable display device 504 and/or based on the additional information transmitted by the second wearable display device 506. The remote device 502 may transmit the single render buffer 524 and the first depth frame 526 to the first wearable display device 504. The remote device 502 may transmit the single render buffer 524 and the second depth frame 528 to the second wearable display device 506.

In an example, at 530, the first wearable display device 504 may detect an occlusion risk. In an example, the first wearable display device 504 may determine the occlusion risk based on the first pose information 510 and/or the first head motion speed 512. In a further example, the first wearable display device 504 may estimate an occlusion region based on the first pose information 510 and/or the first head motion speed 512. The occlusion region may be indicated in a map. In another example, the second wearable display device 506 may detect an occlusion risk based on the first pose information 510 and/or the first head motion speed 512 and the second wearable display device 506 may transmit an indication of the occlusion risk (e.g., an indication of an area that is at risk of being occluded) to the first wearable display device 504 and/or the remote device 502.

At 532, the first wearable display device 504 may request a nearest user (e.g., the second wearable display device 506) for texture data and depth data around the occlusion region. Upon receiving the request, the second wearable display device 506 may transmit the texture data and the depth data to the first wearable display device 504 (or transmit the texture data and the depth data to the remote device 502 which may forward the texture data and the depth data to the first wearable display device 504).

At 534, the first wearable display device 504 may perform an LSR on the single render buffer 524 and/or the first depth frame 526 based on the texture data and the depth data. For instance, the first wearable display device 504 may perform the LSR based on current pose information of the first wearable display device 504 and the texture data and the depth data. At 536, based on performing the LSR, the first wearable display device 504 may display a rendered frame (e.g., a frame from the perspective of the first user) on display panel(s) of the first wearable display device 504.

In an example, at 538, the second wearable display device 506 may detect an occlusion risk. In an example, the second wearable display device 506 may determine the occlusion risk based on the second pose information 516 and/or the second head motion speed 518. In a further example, the second wearable display device 506 may estimate an occlusion region based on the second pose information 516 and/or the second head motion speed 518. The occlusion region may be indicated in a map. In another example, the first wearable display device 504 may detect an occlusion risk based on the second pose information 516 and/or the second head motion speed 518 and the first wearable display device 504 may transmit an indication of the occlusion risk (e.g., an indication of an area that is at risk of being occluded) to the second wearable display device 506 and/or the remote device 502.

At 540, the second wearable display device 506 may request a nearest user (e.g., the first wearable display device 504) for texture data and depth data around the occlusion region. Upon receiving the request, the first wearable display device 504 may transmit the texture data and the depth data to the second wearable display device 506 (or transmit the texture data and the depth data to the remote device 502 which may forward the texture data and the depth data to the second wearable display device 506).

At 542, the second wearable display device 506 may perform an LSR on the single render buffer 524 and/or the second depth frame 528 based on the texture data and the depth data. For instance, the second wearable display device 506 may perform the LSR based on current pose information of the second wearable display device 506 and the texture data and the depth data. At 544, based on performing the LSR, the second wearable display device 506 may display a rendered frame (e.g., a frame from the perspective of the second user) on display panel(s) of the second wearable display device 506.

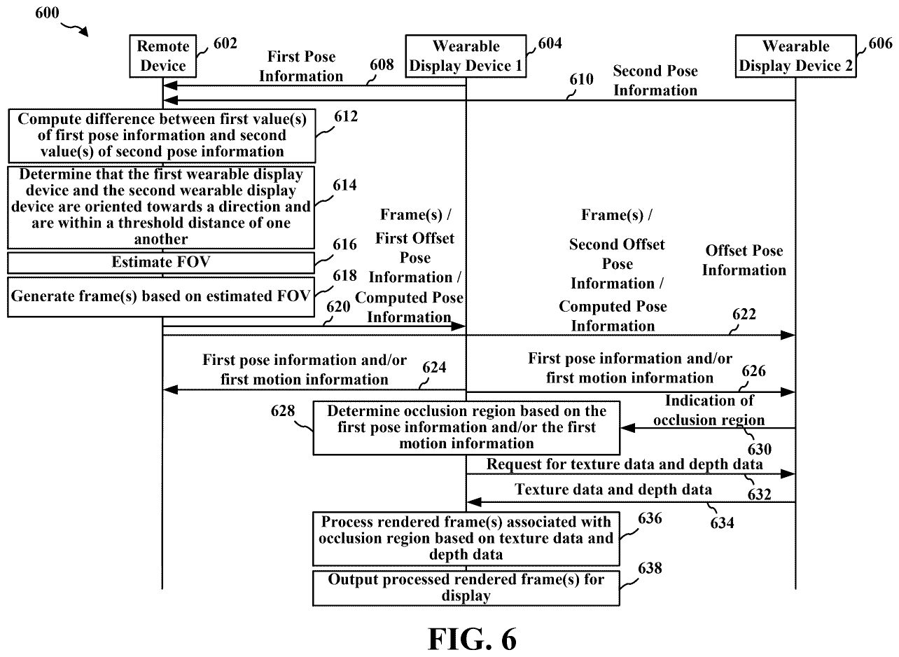

FIG. 6 is a call flow diagram 600 illustrating example communications between a remote device 602, a first wearable display device 604, and a second wearable display device 606 in accordance with one or more techniques of this disclosure. In an example, the remote device 602 may be the remote device 402 or the remote device 502, the first wearable display device 604 may be the first wearable display device 404 or the first wearable display device 504, and the second wearable display device 606 may be the second wearable display device 406 or the second wearable display device 506.

At 608, the remote device 602 may obtain first pose information for the first wearable display device 604. At 610, the remote device 602 may obtain second pose information for the second wearable display device 606. At 612, the remote device 602 may compute a difference between first value(s) of the first pose information and second value(s) of the second pose information. At 614, the remote device 602 may determine that the first wearable display device 604 and the second wearable display device 606 are oriented towards a direction and are within a threshold distance of one another. At 616, the remote device 602 may estimate a FOV of the first wearable display device 604 and the second wearable display device 606 based on at least one of the first pose information or the second pose information. At 618, the remote device 602 may generate, based on the FOV, frame(s) for at least one of the first wearable display device or the second wearable display device. At 620, the remote device 602 may transmit the frame(s) to the first wearable display device 604. The remote device 602 may also transmit first offset pose information and/or computed pose information to the first wearable display device 604. At 622, the remote device 602 may transmit the frame(s) to the second wearable display device 606. The remote device 602 may also transmit second offset pose information and/or computed pose information to the second wearable display device 606.

At 624, the first wearable display device 604 may transmit first pose information and/or first motion information to the remote device 602. At 626, the first wearable display device 604 may transmit the first pose information and/or the first motion information to the second wearable display device 606. At 628, the first wearable display device 604 may determine an occlusion region based on the first pose information and/or the first motion information. For instance, at 630, the second wearable display device 606 may receive an indication of the occlusion region from the second wearable display device 606.

At 632, the first wearable display device 604 may transmit a request for texture and depth data associated with the occlusion region to the second wearable display device 606. At 634, the first wearable display device 604 may obtain the texture data and the depth data from the second wearable display device 606. At 636, the first wearable display device 604 may process frame(s) associated with the occlusion region based on the texture data and the depth data. For instance, the first wearable display device 604 may perform an LSR on the frame(s) based on the texture data and the depth data. At 638, the first wearable display device 604 may output the processed rendered frame(s) for display on display panel(s).

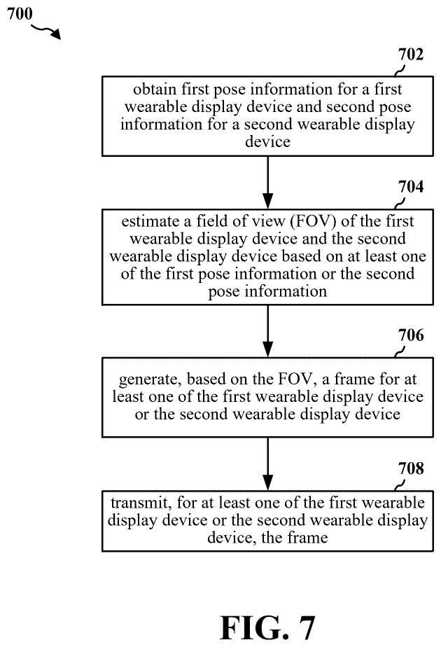

FIG. 7 is a flowchart 700 of an example method of graphics processing in accordance with one or more techniques of this disclosure. The method may be performed by an apparatus, such as an apparatus for graphics processing, a GPU, a CPU, the device 104, the remote device 402, the remote device 502, the remote device 602, a wireless communication device, and the like, as used in connection with the aspects of FIGS. 1-6. In an example, the method may be performed by the split XR renderer 198.

At 702, the apparatus (e.g., a remote device) obtains first pose information for a first wearable display device and second pose information for a second wearable display device. For example, FIG. 6 at 608 and 610 shows that the remote device 602 may obtain first pose information for the first wearable display device 604 and second pose information for the second wearable display device 606. In an example, the first wearable display device may be the first wearable display device 404 and the second wearable display device may be the second wearable display device 406. In an example, the first pose information may be the first pose information 410 and the second pose information may be the second pose information 416. In an example, the first wearable display device may be the first wearable display device 504 and the second wearable display device may be the second wearable display device 506. In an example, the first pose information may be the first pose information 510 and the second pose information may be the second pose information 516. In an example, 702 may be performed by the split XR renderer 198.

At 704, the apparatus (e.g., a remote device) estimates a field of view (FOV) of the first wearable display device and the second wearable display device based on at least one of the first pose information or the second pose information. For example, FIG. 6 at 616 shows that the remote device 602 may estimate a FOV of the first wearable display device 604 and the second wearable display device 606 based on at least one of the first pose information or the second pose information. In another example, FIG. 4 at 420 shows that the remote device 402 may estimate a FOV. In an example, 704 may include aspects described above in connection with FIG. 4 and/or FIG. 5. In an example, 704 may be performed by the split XR renderer 198.

At 706, the apparatus (e.g., a remote device) generates, based on the FOV, a frame for at least one of the first wearable display device or the second wearable display device. For example, FIG. 6 at 618 shows that the remote device 602 may generate, based on the FOV, a frame for at least one of the first wearable display device 604 or the second wearable display device 606. In an example, the frame may be or include the single render buffer 424. In another example, the frame may be or include the single render buffer 424, the first depth frame 426, and/or the second depth frame 428. In an example, the frame may be or include the single render buffer 524. In another example, the frame may be or include the single render buffer 524, the first depth frame 526, and/or the second depth frame 528. In an example, 706 may include aspects described above in connection with FIG. 4 and/or FIG. 5. In an example, 706 may be performed by the split XR renderer 198.

At 708, the apparatus (e.g., a remote device) transmits, for at least one of the first wearable display device or the second wearable display device, the frame. For example, FIG. 6 at 620 and 622 shows that the remote device 602 may transmit, for at least one of the first wearable display device 604 or the second wearable display device 606, the frame. In an example, 708 may be performed by the split XR renderer 198.

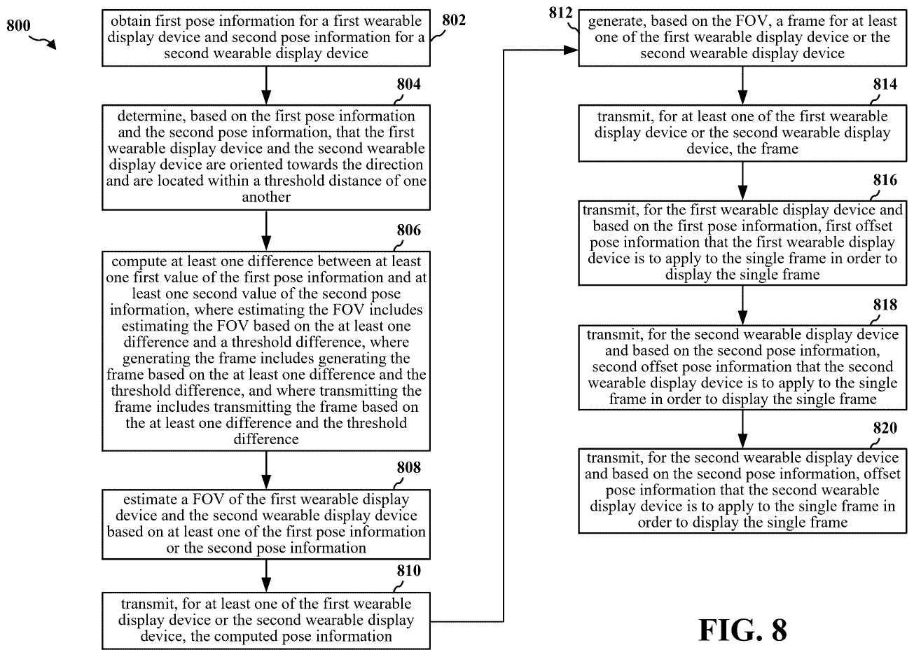

FIG. 8 is a flowchart 800 of an example method of graphics processing in accordance with one or more techniques of this disclosure. The method may be performed by an apparatus, such as an apparatus for graphics processing, a GPU, a CPU, the device 104, the remote device 402, the remote device 502, the remote device 602, a wireless communication device, and the like, as used in connection with the aspects of FIGS. 1-6. In an example, the method (including the various aspects detailed below) may be performed by the split XR renderer 198.

At 802, the apparatus (e.g., a remote device) obtains first pose information for a first wearable display device and second pose information for a second wearable display device. For example, FIG. 6 at 608 and 610 shows that the remote device 602 may obtain first pose information for the first wearable display device 604 and second pose information for the second wearable display device 606. In an example, the first wearable display device may be the first wearable display device 404 and the second wearable display device may be the second wearable display device 406. In an example, the first pose information may be the first pose information 410 and the second pose information may be the second pose information 416. In an example, the first wearable display device may be the first wearable display device 504 and the second wearable display device may be the second wearable display device 506. In an example, the first pose information may be the first pose information 510 and the second pose information may be the second pose information 516. In an example, 802 may be performed by the split XR renderer 198.

At 808, the apparatus (e.g., a remote device) estimates a field of view (FOV) of the first wearable display device and the second wearable display device based on at least one of the first pose information or the second pose information. For example, FIG. 6 at 616 shows that the remote device 602 may estimate a FOV of the first wearable display device 604 and the second wearable display device 606 based on at least one of the first pose information or the second pose information. In another example, FIG. 4 at 420 shows that the remote device 402 may estimate a FOV. In an example, 808 may include aspects described above in connection with FIG. 4 and/or FIG. 5. In an example, 808 may be performed by the split XR renderer 198.

At 812, the apparatus (e.g., a remote device) generates, based on the FOV, a frame for at least one of the first wearable display device or the second wearable display device. For example, FIG. 6 at 618 shows that the remote device 602 may generate, based on the FOV, a frame for at least one of the first wearable display device 604 or the second wearable display device 606. In an example, the frame may be or include the single render buffer 424. In another example, the frame may be or include the single render buffer 424, the first depth frame 426, and/or the second depth frame 428. In an example, the frame may be or include the single render buffer 524. In another example, the frame may be or include the single render buffer 524, the first depth frame 526, and/or the second depth frame 528. In an example, 812 may include aspects described above in connection with FIG. 4 and/or FIG. 5. In an example, 812 may be performed by the split XR renderer 198.

At 814, the apparatus (e.g., a remote device) transmits, for at least one of the first wearable display device or the second wearable display device, the frame. For example, FIG. 6 at 620 and 622 shows that the remote device 602 may transmit, for at least one of the first wearable display device 604 or the second wearable display device 606, the frame. In an example, 814 may be performed by the split XR renderer 198.

In one aspect, obtaining the first pose information for the first wearable display device and the second pose information for the second wearable display device may include: obtaining the first pose information and first motion information for the first wearable display device and the second pose information and second motion information for the second wearable display device. For example, obtaining the first pose information at 608 may include obtaining the first pose information and first motion information for the first wearable display device and obtaining the second pose information at 610 may include obtaining the second pose information and second motion information for the second wearable display device. In an example, the first motion information may be or include the first head motion speed 412 and the second motion information may be or include the second head motion speed 418. In an example, the first motion information may be or include the first head motion speed 512 and the second motion information may be or include the second head motion speed 518.

In one aspect, the frame may include: a first frame for both the first wearable display device and the second wearable display device, a first depth frame for the first wearable display device, and a second depth frame for the second wearable display device. In an example, the first frame for both the first wearable display device and the second wearable display device may be associated with the single render buffer 424, the first depth frame for the first wearable display device may the first depth frame 426, and the second depth frame for the second wearable display device may be the second depth frame 428.

In one aspect, transmitting the frame may include: transmitting, for the first wearable display device, the first frame and the first depth frame. For example, FIG. 6 at 620 shows that transmitting the frame may include transmitting, for the first wearable display device 604, the first frame and the first depth frame. The aforementioned aspect may include aspects described above in connection with FIG. 4 and/or FIG. 5.

In one aspect, transmitting the frame may include: transmitting, for the second wearable display device, the first frame and the second depth frame. For example, FIG. 6 at 622 shows that transmitting the frame may include transmitting, for the second wearable display device 606, the first frame and the second depth frame. The aforementioned aspect may include aspects described above in connection with FIG. 4 and/or FIG. 5.

In one aspect, the frame may include a single frame for both the first wearable display device and the second wearable display device. For example, the single frame for both the first wearable display device and the second wearable display device may correspond to the single render buffer 424 or the single render buffer 524. In another example, the frame transmitted at 620 may be a single frame for both the first wearable display device 604 and the second wearable display device 606. In yet another example, the frame transmitted at 622 may be a single frame for both the first wearable display device 604 and the second wearable display device 606.

In one aspect, the single frame may be from a viewpoint between the first wearable display device and the second wearable display device, and at 816, the apparatus (e.g., a remote device) may transmit, for the first wearable display device and based on the first pose information, first offset pose information that the first wearable display device is to apply to the single frame in order to display the single frame. In an example, the frame(s) transmitted at 620 may be a single frame from a viewpoint between the first wearable display device 604 and the second wearable display device 606. In another example, FIG. 6 at 620 shows that the remote device 602 may transmit first offset pose information that the first wearable display device 604 is to apply to the single frame in order to display the single frame. The aforementioned aspect may include aspects described above in connection with FIG. 4 and/or FIG. 5. In an example, 816 may be performed by the split XR renderer 198.

In one aspect, the single frame may be from a viewpoint between the first wearable display device and the second wearable display device, and at 818, the apparatus (e.g., a remote device) may transmit, for the second wearable display device and based on the second pose information, second offset pose information that the second wearable display device is to apply to the single frame in order to display the single frame. In yet another example, FIG. 6 at 622 shows that the remote device 602 may transmit second offset pose information that the second wearable display device 606 is to apply to the single frame in order to display the single frame. The aforementioned aspect may include aspects described above in connection with FIG. 4 and/or FIG. 5. In an example, 818 may be performed by the split XR renderer 198.

In one aspect, the single frame may be from a viewpoint of the first wearable display device, and at 820, the apparatus (e.g., a remote device) may transmit, for the second wearable display device and based on the second pose information, offset pose information that the second wearable display device is to apply to the single frame in order to display the single frame. In an example, the frame(s) transmitted at 620 may be a single frame from a viewpoint of the first wearable display device 604. In an example, FIG. 6 at 622 shows that the remote device 602 may transmit, for the second wearable display device 606 and based on the second pose information, offset pose information that the second wearable display device is to apply to the single frame in order to display the single frame. In an example, 820 may be performed by the split XR renderer 198.

In one aspect, the first pose information may indicate that the first wearable display device is oriented towards a direction, and the second pose information may indicate that the second wearable display device is oriented towards the direction. For example, the first pose information 410 and the second pose information 416 may indicate that the first wearable display device 404 and the second wearable display device 406 are oriented towards a direction (e.g., the same direction or a similar direction).

In one aspect, at 804, the apparatus (e.g., a remote device) may determine, based on the first pose information and the second pose information, that the first wearable display device and the second wearable display device are oriented towards the direction and are located within a threshold distance of one another. For example, FIG. 6 at 614 shows that the remote device 602 may determine, based on the first pose information and the second pose information, that the first wearable display device and the second wearable display device are oriented towards the direction and are located within a threshold distance of one another. In an example, 804 may be performed by the split XR renderer 198.

In one aspect, estimating the FOV of the first wearable display device and the second wearable display device based on at least one of the first pose information or the second pose information may include computing pose information that is representative of the first pose information and the second pose information. For example, estimating the FOV at 616 may include computing pose information that is representative of the first pose information and the second pose information.

In one aspect, estimating the FOV of the first wearable display device and the second wearable display device based on at least one of the first pose information or the second pose information may include estimating the FOV of the first wearable display device and the second wearable display device based on the computed pose information. For example, estimating the FOV at 616 may include estimating the FOV of the first wearable display device and the second wearable display device based on the computed pose information.

In one aspect, at 810, the apparatus (e.g., a remote device) may transmit, for at least one of the first wearable display device or the second wearable display device, the computed pose information. For example, FIG. 6 at 620 shows that the remote device 602 may transmit computed pose information to the first wearable display device 604. For example, FIG. 6 at 622 shows that the remote device 602 may transmit computed pose information to the second wearable display device 606. In an example, 810 may be performed by the split XR renderer 198.

In one aspect, generating the frame for at least one of the first wearable display device or the second wearable display device may include: generating, based on a multiple view (multi-view) rendering technique, a first frame for the first wearable display device and a second frame for the second wearable display device. For example, generating the frame for at least one of the first wearable display device or the second wearable display device at 618 may include: generating, based on a multiple view (multi-view) rendering technique, a first frame for the first wearable display device 604 and a second frame for the second wearable display device 606.

In one aspect, at 806, the apparatus (e.g., a remote device) may compute at least one difference between at least one first value of the first pose information and at least one second value of the second pose information, and estimating the FOV may include estimating the FOV based on the at least one difference and a threshold difference, where generating the frame may include generating the frame based on the at least one difference and the threshold difference, and where transmitting the frame may include transmitting the frame based on the at least one difference and the threshold difference. For example, FIG. 6 at 612 shows that the remote device 602 may compute at least one difference between at least one first value of the first pose information and at least one second value of the second pose information, and estimating the FOV at 616 may include estimating the FOV based on the at least one difference and a threshold difference, where generating the frame at 618 may include generating the frame based on the at least one difference and the threshold difference, and where transmitting the frame at 620 and/or at 622 may include transmitting the frame based on the at least one difference and the threshold difference. In an example, 806 may be performed by the split XR renderer 198.

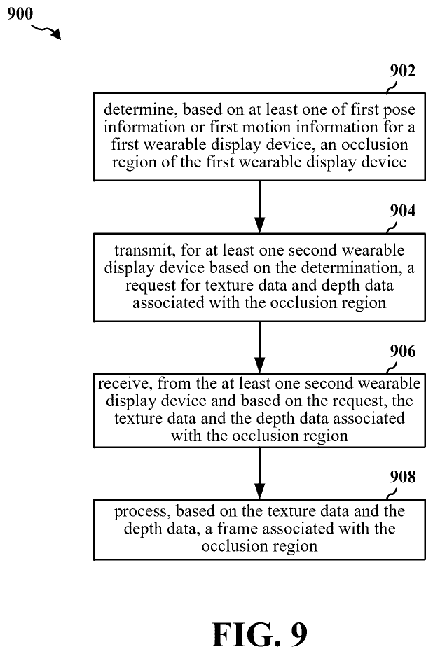

FIG. 9 is a flowchart 900 of an example method of display processing in accordance with one or more techniques of this disclosure. The method may be performed by an apparatus, such as an apparatus for display processing, a display processing unit (DPU) or other display processor, the first wearable display device 404, the second wearable display device 406, the first wearable display device 504, the second wearable display device 506, the first wearable display device 604, the second wearable display device 606, a wireless communication device, and the like, as used in connection with the aspects of FIGS. 1-6. In an example, the method may be performed by the occlusion mitigator 199.

At 902, the apparatus may determine, based on at least one of first pose information or first motion information for a first wearable display device, an occlusion region of the first wearable display device. For example, FIG. 6 at 628 shows that the first wearable display device 604 may determine, based on at least one of first pose information or first motion information for a first wearable display device, an occlusion region of the first wearable display device. In an example, the first pose information and the first motion information may be the first pose information 410 and the first head motion speed 412, respectively. In another example, the first pose information and the first motion information may be the first pose information 510 and the first head motion speed 512, respectively. In a further example, FIG. 5 at 530 shows that the first wearable display device 504 may detect an occlusion risk. In an example, 902 may be performed by the occlusion mitigator 199.

At 904, the apparatus may transmit, for at least one second wearable display device based on the determination, a request for texture data and depth data associated with the occlusion region. For example, FIG. 6 at 632 shows that the first wearable display device 604 may transmit a request for texture data and depth data associated with the occlusion region to the second wearable display device 606 based on the determination at 628. In another example, FIG. 5 at 532 shows that the first wearable display device 504 may request a nearest user (e.g., the second wearable display device 506) for texture and depth data around an estimated occlusion region. In an example, 904 may be performed by the occlusion mitigator 199.

At 906, the apparatus may receive, from the at least one second wearable display device and based on the request, the texture data and the depth data associated with the occlusion region. In an example, FIG. 6 at 634 shows that the first wearable display device 604 may receive the texture data and the depth data associated with the occlusion region from the second wearable display device 606 based on the request transmitted at 632. In an example, 906 may be performed by the occlusion mitigator 199 At 908, the apparatus may process, based on the texture data and the depth data, a frame associated with the occlusion region. For example, FIG. 6 at 636 shows that the first wearable display device 604 may process, based on the texture data and the depth data, the frame associated with the occlusion region. In another example, FIG. 5 at 534 shows that the first wearable display device 504 may perform an LSR on the single render buffer 524 (and/or the first depth frame 526) based on the texture data and the depth data. In an example, 908 may be performed by the occlusion mitigator 199.

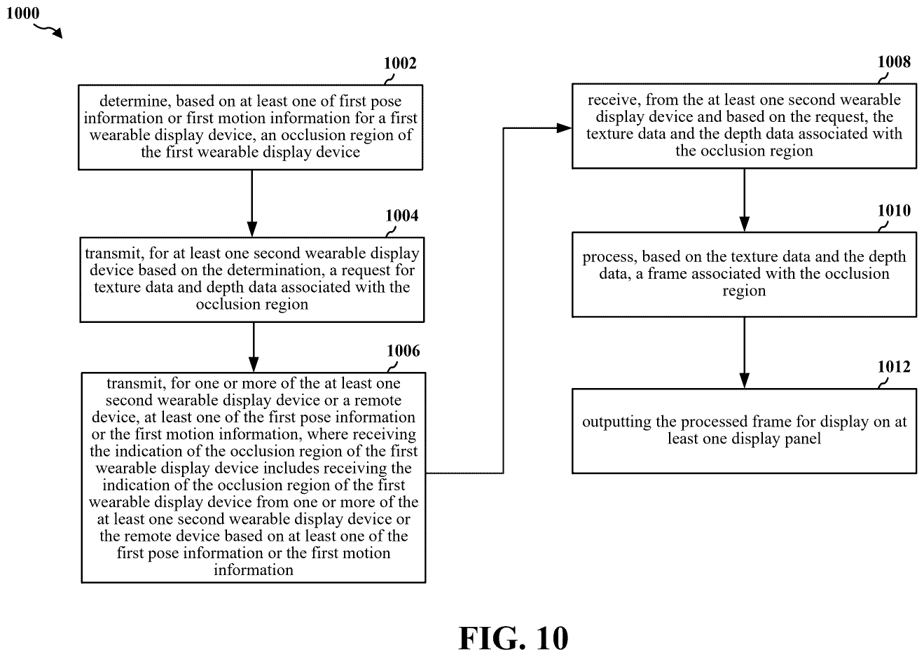

FIG. 10 is a flowchart 1000 of an example method of display processing in accordance with one or more techniques of this disclosure. The method may be performed by an apparatus, such as an apparatus for display processing, a display processing unit (DPU) or other display processor, the first wearable display device 404, the second wearable display device 406, the first wearable display device 504, the second wearable display device 506, the first wearable display device 604, the second wearable display device 606, a wireless communication device, and the like, as used in connection with the aspects of FIGS. 1-6. In an example, the method (including the various aspects detailed below) may be performed by the occlusion mitigator 199.

At 1002, the apparatus may determine, based on at least one of first pose information or first motion information for a first wearable display device, an occlusion region of the first wearable display device. For example, FIG. 6 at 628 shows that the first wearable display device 604 may determine, based on at least one of first pose information or first motion information for a first wearable display device, an occlusion region of the first wearable display device. In an example, the first pose information and the first motion information may be the first pose information 410 and the first head motion speed 412, respectively. In another example, the first pose information and the first motion information may be the first pose information 510 and the first head motion speed 512, respectively. In a further example, FIG. 5 at 530 shows that the first wearable display device 504 may detect an occlusion risk. In an example, 1002 may be performed by the occlusion mitigator 199.

At 1004, the apparatus may transmit, for at least one second wearable display device based on the determination, a request for texture data and depth data associated with the occlusion region. For example, FIG. 6 at 632 shows that the first wearable display device 604 may transmit a request for texture data and depth data associated with the occlusion region to the second wearable display device 606 based on the determination at 628. In another example, FIG. 5 at 532 shows that the first wearable display device 504 may request a nearest user (e.g., the second wearable display device 506) for texture and depth data around an estimated occlusion region. In an example, 1004 may be performed by the occlusion mitigator 199.

At 1008, the apparatus may receive, from the at least one second wearable display device and based on the request, the texture data and the depth data associated with the occlusion region. In an example, FIG. 6 at 634 shows that the first wearable display device 604 may receive the texture data and the depth data associated with the occlusion region from the second wearable display device 606 based on the request transmitted at 632. In an example, 1008 may be performed by the occlusion mitigator 199.

At 1010, the apparatus may process, based on the texture data and the depth data, a frame associated with the occlusion region. For example, FIG. 6 at 636 shows that the first wearable display device 604 may process, based on the texture data and the depth data, the frame associated with the occlusion region. In another example, FIG. 5 at 534 shows that the first wearable display device 504 may perform an LSR on the single render buffer 524 (and/or the first depth frame 526) based on the texture data and the depth data. In an example, 1010 may be performed by the occlusion mitigator 199 In one aspect, determining the occlusion region of the first wearable display device may include: estimating, based on at least one of the first pose information or the first motion information for the first wearable display device, the occlusion region of the first wearable display device. For example, determining the occlusion region of the first wearable display device 604 at 628 may include: estimating, based on at least one of the first pose information or the first motion information for the first wearable display device 604, the occlusion region of the first wearable display device.

In one aspect, determining the occlusion region of the first wearable display device may include: receiving an indication of the occlusion region of the first wearable display device. For example, FIG. 6 at 630 shows that the first wearable display device 604 may receive an indication of the occlusion region of the first wearable display device 604 from the second wearable display device 606.

In one aspect, at 1006, the apparatus may transmit, for one or more of the at least one second wearable display device or a remote device, at least one of the first pose information or the first motion information, where receiving the indication of the occlusion region of the first wearable display device may include receiving the indication of the occlusion region of the first wearable display device from one or more of the at least one second wearable display device or the remote device based on at least one of the first pose information or the first motion information. For example, FIG. 6 at 626 and 624 shows that the first wearable display device 604 may transmit first pose information and/or first motion information to the remote device 602 and/or the second wearable display device 606, respectively. In another example, receiving the indication of the occlusion region of the first wearable display device 604 at 630 may be based on the first pose information and/or first motion information. In an example, 1006 may be performed by the occlusion mitigator 199.

In one aspect, the indication of the occlusion region of the first wearable display device may include a map including the occlusion region of the first wearable display device. For example, the indication of the occlusion region determined at 628 may include a map including the occlusion region of the first wearable display device 604.

In one aspect, processing the frame associated with the occlusion region may include performing a late stage reprojection on the frame based on the texture data and the depth data. For example, processing the frame associated with the occlusion region at 636 may include performing a late stage reprojection on the frame based on the texture data and the depth data. In another example, FIG. 5 at 534 shows that the first wearable display device 504 may perform an LSR on the frame based on the texture data and the depth data.

In one aspect, at 1012, the apparatus may output the processed frame for display on at least one display panel. For example, FIG. 6 at 638 shows that the first wearable display device 604 may output the processed frame for display on at least one display panel. In an example, the at least one display panel may be or include the display(s) 131. In an example, 1012 may be performed by the occlusion mitigator 199.

In one aspect, the frame may include: a first frame for the first wearable display device, and a depth frame for the first wearable display device. For example, the first frame may be included in/associated with the single render buffer 524 and the depth frame may be the first depth frame 526.

In configurations, a method or an apparatus for graphics processing is provided. The apparatus may be a GPU, a CPU, or some other processor that may perform graphics processing. In aspects, the apparatus may be the processing unit 120 within the device 104, or may be some other hardware within the device 104 or another device. The apparatus (e.g., the processing unit 120) may include means for obtaining first pose information for a first wearable display device and second pose information for a second wearable display device. The apparatus (e.g., the processing unit 120) may further include means for estimating a field of view (FOV) of the first wearable display device and the second wearable display device based on at least one of the first pose information or the second pose information. The apparatus (e.g., the processing unit 120) may further include means for generating, based on the FOV, a frame for at least one of the first wearable display device or the second wearable display device. The apparatus (e.g., the processing unit 120) may further include means for transmitting, for at least one of the first wearable display device or the second wearable display device, the frame. The apparatus (e.g., the processing unit 120) may further include means for transmitting, for the first wearable display device and based on the first pose information, first offset pose information that the first wearable display device is to apply to the single frame in order to display the single frame. The apparatus (e.g., the processing unit 120) may further include means for transmitting, for the second wearable display device and based on the second pose information, second offset pose information that the second wearable display device is to apply to the single frame in order to display the single frame. The apparatus (e.g., the processing unit 120) may further include means for transmitting, for the second wearable display device and based on the second pose information, offset pose information that the second wearable display device is to apply to the single frame in order to display the single frame. The apparatus (e.g., the processing unit 120) may further include means for determining, based on the first pose information and the second pose information, that the first wearable display device and the second wearable display device are oriented towards the direction and are located within a threshold distance of one another. The apparatus (e.g., the processing unit 120) may further include means for transmitting, for at least one of the first wearable display device or the second wearable display device, the computed pose information. The apparatus (e.g., the processing unit 120) may further include means for computing at least one difference between at least one first value of the first pose information and at least one second value of the second pose information, where estimating the FOV includes estimating the FOV based on the at least one difference and a threshold difference, where generating the frame includes generating the frame based on the at least one difference and the threshold difference, and where transmitting the frame includes transmitting the frame based on the at least one difference and the threshold difference.

In configurations, a method or an apparatus for display processing is provided. The apparatus may be a DPU, a display processor, or some other processor that may perform display processing. In aspects, the apparatus may be the display processor 127 within the device 104, or may be some other hardware within the device 104 or another device. The apparatus (e.g., the display processor 127) may include means for determining, based on at least one of first pose information or first motion information for a first wearable display device, an occlusion region of the first wearable display device. The apparatus (e.g., the display processor 127) may further include means for transmitting, for at least one second wearable display device based on the determination, a request for texture data and depth data associated with the occlusion region. The apparatus (e.g., the display processor 127) may further include means for receiving, from the at least one second wearable display device and based on the request, the texture data and the depth data associated with the occlusion region. The apparatus (e.g., the display processor 127) may further include means for processing, based on the texture data and the depth data, a frame associated with the occlusion region. The apparatus (e.g., the display processor 127) may further include means for transmitting, for one or more of the at least one second wearable display device or a remote device, at least one of the first pose information or the first motion information, where receiving the indication of the occlusion region of the first wearable display device includes receiving the indication of the occlusion region of the first wearable display device from one or more of the at least one second wearable display device or the remote device based on at least one of the first pose information or the first motion information. The apparatus (e.g., the display processor 127) may further include means for outputting the processed frame for display on at least one display panel.

It is understood that the specific order or hierarchy of blocks/steps in the processes, flowcharts, and/or call flow diagrams disclosed herein is an illustration of example approaches. Based upon design preferences, it is understood that the specific order or hierarchy of the blocks/steps in the processes, flowcharts, and/or call flow diagrams may be rearranged. Further, some blocks/steps may be combined and/or omitted. Other blocks/steps may also be added. The accompanying method claims present elements of the various blocks/steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, where reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects.

Unless specifically stated otherwise, the term “some” refers to one or more and the term “or” may be interpreted as “and/or” where context does not dictate otherwise. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.” Unless stated otherwise, the phrase “a processor” may refer to “any of one or more processors” (e.g., one processor of one or more processors, a number (greater than one) of processors in the one or more processors, or all of the one or more processors) and the phrase “a memory” may refer to “any of one or more memories” (e.g., one memory of one or more memories, a number (greater than one) of memories in the one or more memories, or all of the one or more memories).

In one or more examples, the functions described herein may be implemented in hardware, software, firmware, or any combination thereof. For example, although the term “processing unit” has been used throughout this disclosure, such processing units may be implemented in hardware, software, firmware, or any combination thereof. If any function, processing unit, technique described herein, or other module is implemented in software, the function, processing unit, technique described herein, or other module may be stored on or transmitted over as one or more instructions or code on a computer-readable medium.

Computer-readable media may include computer data storage media or communication media including any medium that facilitates transfer of a computer program from one place to another. In this manner, computer-readable media generally may correspond to: (1) tangible computer-readable storage media, which is non-transitory; or (2) a communication medium such as a signal or carrier wave. Data storage media may be any available media that can be accessed by one or more computers or one or more processors to retrieve instructions, code, and/or data structures for implementation of the techniques described in this disclosure. By way of example, and not limitation, such computer-readable media may include RAM, ROM, EEPROM, compact disc-read only memory (CD-ROM), or other optical disk storage, magnetic disk storage, or other magnetic storage devices. Disk and disc, as used herein, includes compact disc (CD), laser disc, optical disc, digital versatile disc (DVD), floppy disk, and Blu-ray disc, where disks usually reproduce data magnetically, while discs usually reproduce data optically with lasers. Combinations of the above should also be included within the scope of computer-readable media. A computer program product may include a computer-readable medium.

The techniques of this disclosure may be implemented in a wide variety of devices or apparatuses, including a wireless handset, an integrated circuit (IC) or a set of ICs, e.g., a chip set. Various components, modules or units are described in this disclosure to emphasize functional aspects of devices configured to perform the disclosed techniques, but do not necessarily need realization by different hardware units. Rather, as described above, various units may be combined in any hardware unit or provided by a collection of inter-operative hardware units, including one or more processors as described above, in conjunction with suitable software and/or firmware. Accordingly, the term “processor,” as used herein may refer to any of the foregoing structure or any other structure suitable for implementation of the techniques described herein. Also, the techniques may be fully implemented in one or more circuits or logic elements.

The following aspects are illustrative only and may be combined with other aspects or teachings described herein, without limitation.

Aspect 1 a method of graphics processing, comprising: obtaining first pose information for a first wearable display device and second pose information for a second wearable display device; estimating a field of view (FOV) of the first wearable display device and the second wearable display device based on at least one of the first pose information or the second pose information; generating, based on the FOV, a frame for at least one of the first wearable display device or the second wearable display device; and transmitting, for at least one of the first wearable display device or the second wearable display device, the frame.

Aspect 2 may be combined with aspect 1 and comprises that obtaining the first pose information for the first wearable display device and the second pose information for the second wearable display device comprises: obtaining the first pose information and first motion information for the first wearable display device and the second pose information and second motion information for the second wearable display device.

Aspect 3 may be combined with any of aspects 1-2 and comprises that the frame comprises: a first frame for both the first wearable display device and the second wearable display device, a first depth frame for the first wearable display device, and a second depth frame for the second wearable display device.

Aspect 4 may be combined with aspect 3 and comprises that transmitting the frame comprises: transmitting, for the first wearable display device, the first frame and the first depth frame; and transmitting, for the second wearable display device, the first frame and the second depth frame.

Aspect 5 may be combined with any of aspects 1-2 and comprises that the frame comprises a single frame for both the first wearable display device and the second wearable display device.

Aspect 6 may be combined with aspect 5 and comprises that the single frame is from a viewpoint between the first wearable display device and the second wearable display device, the method further comprising: transmitting, for the first wearable display device and based on the first pose information, first offset pose information that the first wearable display device is to apply to the single frame in order to display the single frame; and transmitting, for the second wearable display device and based on the second pose information, second offset pose information that the second wearable display device is to apply to the single frame in order to display the single frame.

Aspect 7 may be combined with aspect 5 and comprises that the single frame is from a viewpoint of the first wearable display device, the method further comprising: transmitting, for the second wearable display device and based on the second pose information, offset pose information that the second wearable display device is to apply to the single frame in order to display the single frame.

Aspect 8 may be combined with any of aspects 1-7 and comprises that the first pose information indicates that the first wearable display device is oriented towards a direction, and wherein the second pose information indicates that the second wearable display device is oriented towards the direction.

Aspect 9 may be combined with aspect 8, further comprising determining, based on the first pose information and the second pose information, that the first wearable display device and the second wearable display device are oriented towards the direction and are located within a threshold distance of one another.

Aspect 10 may be combined with any of aspects 1-9 and comprises that estimating the FOV of the first wearable display device and the second wearable display device based on at least one of the first pose information or the second pose information comprises: computing pose information that is representative of the first pose information and the second pose information; and estimating the FOV of the first wearable display device and the second wearable display device based on the computed pose information.

Aspect 11 may be combined with aspect 10, further comprising transmitting, for at least one of the first wearable display device or the second wearable display device, the computed pose information.

Aspect 12 may be combined with any of aspects 1-2 or 8-11 and comprises that generating the frame for at least one of the first wearable display device or the second wearable display device comprises: generating, based on a multiple view (multi-view) rendering technique, a first frame for the first wearable display device and a second frame for the second wearable display device.

Aspect 13 may be combined with any of aspects 1-12, further comprising computing at least one difference between at least one first value of the first pose information and at least one second value of the second pose information, wherein estimating the FOV comprises estimating the FOV based on the at least one difference and a threshold difference, wherein generating the frame comprises generating the frame based on the at least one difference and the threshold difference, and wherein transmitting the frame comprises transmitting the frame based on the at least one difference and the threshold difference.

Aspect 14 is an apparatus for graphics processing comprising a processor coupled to a memory and, based on information stored in the memory, the processor is configured to implement a method as in any of aspects 1-13.

Aspect 15 may be combined with aspect 14 and comprises that the apparatus is a wireless communication device comprising at least one of a transceiver or an antenna coupled to the processor, wherein to transmit the frame, the processor is configured to transmit the frame via at least one of the transceiver or the antenna.

Aspect 16 is an apparatus for graphics processing comprising means for implementing a method as in any of aspects 1-13.

Aspect 17 is a computer-readable medium (e.g., a non-transitory computer readable storage medium) storing computer executable code, the computer executable code, when executed by a processor, causes the processor to implement a method as in any of aspects 1-13.

Aspect 18 is a method of display processing, comprising: determining, based on at least one of first pose information or first motion information for a first wearable display device, an occlusion region of the first wearable display device; transmitting, for at least one second wearable display device based on the determination, a request for texture data and depth data associated with the occlusion region; receiving, from the at least one second wearable display device and based on the request, the texture data and the depth data associated with the occlusion region; and processing, based on the texture data and the depth data, a frame associated with the occlusion region.

Aspect 19 may be combined with aspect 18 and comprises that determining the occlusion region of the first wearable display device comprises: estimating, based on at least one of the first pose information or the first motion information for the first wearable display device, the occlusion region of the first wearable display device.

Aspect 20 may be combined with aspect 18 and comprises that determining the occlusion region of the first wearable display device comprises: receiving an indication of the occlusion region of the first wearable display device.

Aspect 21 may be combined with aspect 20, further comprising transmitting, for one or more of the at least one second wearable display device or a remote device, at least one of the first pose information or the first motion information, wherein receiving the indication of the occlusion region of the first wearable display device comprises receiving the indication of the occlusion region of the first wearable display device from one or more of the at least one second wearable display device or the remote device based on at least one of the first pose information or the first motion information.

Aspect 22 may be combined with any of aspects 18-21 and comprises that the indication of the occlusion region of the first wearable display device comprises a map comprising the occlusion region of the first wearable display device.

Aspect 23 may be combined with any of aspects 18-22 and comprises that processing the frame associated with the occlusion region comprises performing a late stage reprojection on the frame based on the texture data and the depth data.

Aspect 24 may be combined with any of aspects 18-23, further comprising outputting the processed frame for display on at least one display panel.

Aspect 25 may be combined with any of aspects 18-24 and comprises that the frame comprises: a first frame for the first wearable display device, and a depth frame for the first wearable display device.

Aspect 26 is an apparatus for display processing comprising a processor coupled to a memory and, based on information stored in the memory, the processor is configured to implement a method as in any of aspects 18-25.

Aspect 27 may be combined with aspect 26 and comprises that the apparatus is a wireless communication device comprising at least one of a transceiver or an antenna coupled to the processor, wherein to transmit the request for the texture data and the depth data associated with the occlusion region, the processor is configured to transmit the request via at least one of the transceiver or the antenna.

Aspect 28 is an apparatus for display processing comprising means for implementing a method as in any of aspects 18-25.

Aspect 29 is a computer-readable medium (e.g., a non-transitory computer readable storage medium) storing computer executable code, the computer executable code, when executed by a processor, causes the processor to implement a method as in any of aspects 18-25.

Various aspects have been described herein. These and other aspects are within the scope of the following claims.

1. An apparatus for graphics processing, comprising:
a memory; and
a processor coupled to the memory and, based on information stored in the memory, the processor is configured to:
obtain first pose information for a first wearable display device and second pose information for a second wearable display device;
estimate a field of view (FOV) of the first wearable display device and the second wearable display device based on at least one of the first pose information or the second pose information;
generate, based on the FOV, a frame for at least one of the first wearable display device or the second wearable display device; and
transmit, for at least one of the first wearable display device or the second wearable display device, the frame.

2. The apparatus of claim 1, wherein to obtain the first pose information for the first wearable display device and the second pose information for the second wearable display device, the processor is configured to:
obtain the first pose information and first motion information for the first wearable display device and the second pose information and second motion information for the second wearable display device.

3. The apparatus of claim 1, wherein the frame comprises:
a first frame for both the first wearable display device and the second wearable display device,
a first depth frame for the first wearable display device, and
a second depth frame for the second wearable display device.

4. The apparatus of claim 3, wherein to transmit the frame, the processor is configured to:
transmit, for the first wearable display device, the first frame and the first depth frame; and
transmit, for the second wearable display device, the first frame and the second depth frame.

5. The apparatus of claim 1, wherein the frame comprises a single frame for both the first wearable display device and the second wearable display device.

6. The apparatus of claim 5, wherein the single frame is from a viewpoint between the first wearable display device and the second wearable display device, wherein the processor is further configured to:
transmit, for the first wearable display device and based on the first pose information, first offset pose information that the first wearable display device is to apply to the single frame in order to display the single frame; and
transmit, for the second wearable display device and based on the second pose information, second offset pose information that the second wearable display device is to apply to the single frame in order to display the single frame.

7. The apparatus of claim 5, wherein the single frame is from a viewpoint of the first wearable display device, wherein the processor is further configured to:
transmit, for the second wearable display device and based on the second pose information, offset pose information that the second wearable display device is to apply to the single frame in order to display the single frame.

8. The apparatus of claim 1, wherein the first pose information indicates that the first wearable display device is oriented towards a direction, and wherein the second pose information indicates that the second wearable display device is oriented towards the direction.

9. The apparatus of claim 8, wherein the processor is further configured to:
determine, based on the first pose information and the second pose information, that the first wearable display device and the second wearable display device are oriented towards the direction and are located within a threshold distance of one another.

10. The apparatus of claim 1, wherein to estimate the FOV of the first wearable display device and the second wearable display device based on at least one of the first pose information or the second pose information, the processor is configured to:
compute pose information that is representative of the first pose information and the second pose information; and
estimate the FOV of the first wearable display device and the second wearable display device based on the computed pose information.

11. The apparatus of claim 10, wherein the processor is further configured to:
transmit, for at least one of the first wearable display device or the second wearable display device, the computed pose information.

12. The apparatus of claim 1, wherein to generate the frame for at least one of the first wearable display device or the second wearable display device, the processor is configured to:
generate, based on a multiple view (multi-view) rendering technique, a first frame for the first wearable display device and a second frame for the second wearable display device.

13. The apparatus of claim 1, wherein the processor is further configured to:
compute at least one difference between at least one first value of the first pose information and at least one second value of the second pose information, wherein to estimate the FOV, the processor is configured to estimate the FOV based on the at least one difference and a threshold difference, wherein to generate the frame, the processor is configured to generate the frame based on the at least one difference and the threshold difference, and wherein to transmit the frame, the frame is configured to transmit the frame based on the at least one difference and the threshold difference.

14. The apparatus of claim 1, wherein the apparatus is a wireless communication device comprising at least one of a transceiver or an antenna coupled to the processor, wherein to transmit the frame, the processor is configured to transmit the frame via at least one of the transceiver or the antenna.

15. An apparatus for display processing, comprising:
a memory; and
a processor coupled to the memory and, based on information stored in the memory, the processor is configured to:
determine, based on at least one of first pose information or first motion information for a first wearable display device, an occlusion region of the first wearable display device;
transmit, for at least one second wearable display device based on the determination, a request for texture data and depth data associated with the occlusion region;
receive, from the at least one second wearable display device and based on the request, the texture data and the depth data associated with the occlusion region; and
process, based on the texture data and the depth data, a frame associated with the occlusion region.

16. The apparatus of claim 15, wherein to determine the occlusion region of the first wearable display device, the processor is configured to:
estimate, based on at least one of the first pose information or the first motion information for the first wearable display device, the occlusion region of the first wearable display device.

17. The apparatus of claim 15, to determine the occlusion region of the first wearable display device, the processor is configured to:
receive an indication of the occlusion region of the first wearable display device.

18. The apparatus of claim 17, wherein the processor is further configured to:
transmit, for one or more of the at least one second wearable display device or a remote device, at least one of the first pose information or the first motion information, wherein to receive the indication of the occlusion region of the first wearable display device, the processor is configured to receive the indication of the occlusion region of the first wearable display device from one or more of the at least one second wearable display device or the remote device based on at least one of the first pose information or the first motion information.

19. The apparatus of claim 17, wherein the indication of the occlusion region of the first wearable display device comprises a map including the occlusion region of the first wearable display device.

20.-23. (canceled)

24. A method of graphics processing, comprising:
obtaining first pose information for a first wearable display device and second pose information for a second wearable display device;
estimating a field of view (FOV) of the first wearable display device and the second wearable display device based on at least one of the first pose information or the second pose information;
generating, based on the FOV, a frame for at least one of the first wearable display device or the second wearable display device; and
transmitting, for at least one of the first wearable display device or the second wearable display device, the frame.

25.-30. (canceled)
